(19) United States
(12) Patent Application Publication
(10) Pub. No.: US 2026/0336285 A1
(43) Pub. Date: Oct. 29, 2026

(54) PRINT ELEMENT SUBSTRATE

(71) Applicant: CANON KABUSHIKI KAISHA, Tokyo (JP)

(72) Inventors: KENJI FUKADA, Tokyo (JP); TOSHIO NEGISHI, Kanagawa (JP)

(21) Appl. No.: 19/640,943

(22) Filed: Apr. 7, 2026

(30) Foreign Application Priority Data
Apr. 23, 2025 (JP) 2025-071736

(51) Int. Cl. B41J 2/14; B41J 2/045; B41J 2/175

(52) U.S. Cl. CPC B41J 2/14072; B41J 2/04548; B41J 2/0458; B41J 2/175; B41J 2002/14491; B41J 2202/12

(57) ABSTRACT

A print element substrate includes: a first drive element array including a plurality of first drive elements configured to drive a plurality of first heating resistance elements, the plurality of first drive elements being arranged in an array; a second drive element array including a plurality of second drive elements configured to drive a plurality of second heating resistance elements, the plurality of second drive elements being arranged in an array; first wiring lines configured to connect the first heating resistance elements and the first drive elements; and second wiring lines configured to connect the second heating resistance elements and the second drive elements. The second drive element array is arranged on the same layer as the first drive element array in parallel, and is arranged at a position farther away from a heating resistance element region than the first drive element array.

### BACKGROUND

### FIELD OF THE TECHNOLOGY

The present disclosure relates to an arrangement technique of drive elements in a print element substrate.

### DESCRIPTION OF THE RELATED ART

A circulation type liquid ejection apparatus that circulates an ink in a liquid ejection head has been conventionally known. Japanese Patent Laid-Open No. 2020-104493 (hereinafter, referred to as Literature 1) discloses, as the circulation type liquid ejection apparatus, a configuration provided with ejection energy generation elements for ejecting an ink and circulation energy generation elements for circulating the ink. Moreover, the circulation type liquid ejection apparatus uses drive elements for driving the ejection energy generation elements and the circulation energy generation elements, respectively.

Literature 1 discloses a configuration in which an array of the ejection energy generation elements and an array of the circulation energy generation elements are arranged in parallel. Accordingly, the drive elements are provided for the ejection energy generation elements and the circulation energy generation elements, respectively, in a print element substrate, but there is a case where the drive elements cannot be appropriately arranged in the print element substrate.

### SUMMARY

A print element substrate according to one aspect of the present disclosure includes: a first drive element array including a plurality of first drive elements configured to drive a plurality of first heating resistance elements, the plurality of first drive elements being arranged in an array; a second drive element array including a plurality of second drive elements configured to drive a plurality of second heating resistance elements, the plurality of second drive elements being arranged in an array; a plurality of first wiring lines configured to connect the plurality of first heating resistance elements and the plurality of first drive elements; and a plurality of second wiring lines configured to connect the plurality of second heating resistance elements and the plurality of second drive elements, the second drive element array is arranged on a same layer as the first drive element array in parallel with the first drive element array, and is arranged at a position farther away from a heating resistance element region than the first drive element array, the heating resistance element region including the plurality of first heating resistance elements and the plurality of second heating resistance elements being arranged, and the plurality of second wiring lines are formed in a different layer from the plurality of first wiring lines.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective diagram schematically illustrating a liquid ejection apparatus in which ink tanks are provided outside a liquid ejection head as liquid reservoirs;

FIG. 1B is a perspective diagram schematically illustrating a liquid ejection apparatus in which ink sub-tanks are provided directly above the liquid ejection head;

FIG. 2A is an exploded perspective diagram of the liquid ejection head in FIGS. 1A and 1B;

FIG. 2B is a diagram illustrating a case where the number of colors that can be ejected by one liquid ejection chip is four;

FIG. 2C is a diagram illustrating a case where the number of colors that can be ejected by one liquid ejection chip is two;

FIG. 2D is a diagram illustrating a case where the number of colors that can be ejected by one liquid ejection chip is one;

FIG. 3A is a plan diagram as viewed in a direction in which a liquid droplet is ejected from an ejection orifice of an individual ejection unit;

FIG. 3B is a IIIB-IIIB cross-sectional diagram of FIG. 3A;

FIG. 3C is a IIIB-IIIB cross-sectional diagram of FIG. 3A, and is a cross-sectional diagram in which a configuration inside a print element substrate is different from that in FIG. 3B;

FIG. 3D is a diagram explaining flow-in of an ink in the case where a first energy generation element is driven;

FIG. 4A is a IIIB-IIIB cross-sectional diagram of the individual ejection unit in FIG. 3A, and is a cross-sectional diagram for explaining a generation and growth process of an air bubble generated by heating the ink with a second energy generation element and causing film boiling of the ink;

FIG. 4B is an IIIB-IIIB cross-sectional diagram of the individual ejection unit in FIG. 3A, and is a cross-sectional diagram for explaining a contraction process of the air bubble generated by heating the ink with the second energy generation element and causing film boiling of the ink;

FIG. 4C is a IIIB-IIIB cross-sectional diagram of the individual ejection unit in FIG. 3A, and is a cross-sectional diagram for explaining a process after disappearing of the air bubble generated by heating the ink with the second energy generation element and causing film boiling of the ink;

FIG. 5A is a diagram illustrating a state where a circulatory flow of the ink is temporarily paused;

FIG. 5B is a diagram illustrating a state immediately after generation of the circulatory flow of the ink performed by driving the second energy generation element after the state of FIG. 5A;

FIG. 5C is a diagram illustrating a state where the circulatory flow of the ink is temporarily paused after the state of FIG. 5B;

FIG. 5D is a diagram illustrating a state immediately after generation of the circulatory flow of the ink performed by driving the second energy generation element after the state of FIG. 5C;

FIG. 6A is a diagram illustrating a state where the circulatory flow of the ink is temporarily paused;

FIG. 6B is a diagram illustrating a state immediately after generation of the circulatory flow of the ink performed by driving the second energy generation element after the state of FIG. 6A;

FIG. 6C is a diagram illustrating a state where the circulatory flow of the ink is temporarily paused after the state of FIG. 6B;

FIG. 6D is a diagram illustrating a state immediately after generation of the circulatory flow of the ink performed by driving the second energy generation element after the state of FIG. 6C;

FIG. 7A is a plan diagram as viewed in the direction in which the liquid droplet is ejected from the ejection orifice 11;

FIG. 7B is a VIIB-VIIB cross-sectional diagram of FIG. 7A;

FIG. 7C is an enlarged schematic diagram of the individual channel in FIG. 7A;

FIG. 8A is a plan diagram as viewed in the direction in which the liquid droplet is ejected from the ejection orifice;

FIG. 8B is a VIIIB-VIIIB cross-sectional diagram of FIG. 8A;

FIG. 8C is a VIIIB-VIIIB cross-sectional diagram of FIG. 8A, and is a cross-sectional diagram in which the configuration inside the print element substrate is different from that in FIG. 8B;

FIG. 9A is a plan diagram as viewed in the direction in which the liquid droplet is ejected from the ejection orifice;

FIG. 9B is a IXB-IXB cross-sectional diagram of FIG. 9A;

FIG. 9C is a IXB-IXB cross-sectional diagram of FIG. 9A, and is a cross-sectional diagram in which the configuration inside the print element substrate is different from that in FIG. 9B;

FIG. 10 is a diagram illustrating a circuit configuration example of a print element substrate according to the present embodiment;

FIG. 11A is a functional block diagram of a circuit configuration of a control data supply circuit;

FIG. 11B is a diagram illustrating an example of a circuit configuration of a circulation group selection circuit in FIG. 11A;

FIG. 12 is a diagram illustrating an arrangement example of heaters and drive elements in a first case according to the present embodiment;

FIG. 13 is a partial enlarged diagram of the arrangement example of the heaters and the drive elements in the first case in FIG. 12;

FIG. 14 is a diagram illustrating a cross-sectional structure along the XIV-XIV line in FIG. 13;

FIG. 15 is a diagram illustrating an arrangement comparative example of the heaters and the drive elements;

FIG. 16 is a diagram illustrating an arrangement example of the heaters and the drive elements in a second case according to the present embodiment; and

FIG. 17 is a diagram illustrating an arrangement example of the heaters and the drive elements in a third case according to the present embodiment.

### DESCRIPTION OF THE EMBODIMENTS

A preferrable embodiment of the present disclosure is explained below in detail with reference to the attached drawings. Note that the following embodiment does not limit the matters of the present disclosure, and not all of combinations of features explained in the following embodiment are necessarily essential for solving means of the present disclosure. Note that identical constituent elements are denoted by identical reference numerals.

### (Outline)

For example, an ink-jet print head that ejects an ink (also referred to as liquid) has been conventionally known as a liquid ejection head. The ink-jet print head includes ejection orifices that eject the ink. Volatile components in the ink sometimes evaporate from these ejection orifices. Accordingly, the ink in the ejection orifices sometimes thicken due to evaporation of the volatile components in the ink. Such thickening of the ink changes an ejection speed of the ink. In the case where the ejection speed of the ink changes, a case where a landing accuracy of the ink is not as high as desired may occur. Specifically, a decrease in the landing accuracy of the ink may cause ejection failure. Particularly, in the case where a pause time period of an ejection operation of the ink is long, an increase in the viscosity of the ink may become significant. If the increase in the viscosity of the ink is significant, a case where solid contents in the ink fixedly attach to insides of the ejection orifices may occur. In such a case, a flow resistance of the ink increases. Accordingly, an ejection failure of the ink may tend to occur.

As one of countermeasures against a thickening phenomenon of the liquid as described above, causing refreshed liquid to flow to the ejection orifices is known. As a method of causing the liquid to flow, for example, there is a method of using, for example, a pump as a configuration provided on the main body side in addition to a constituent element that performs ejection. A pressure difference can be generated in the liquid in the ink-jet print head by using this pump. This pressure difference may be used to circulate the liquid. Alternatively, there is a method in which a circulation element is provided in the constituent element itself that performs ejection. In the case where a heating resistance element is used as the circulation element, the heating resistance element can cause the liquid to bubble. The liquid can be circulated by using this bubbling.

There is disclosed a technique in which ejection heaters for an ink ejection operation and circulation heaters for an ink circulation operation are used after a state where no liquid is ejected from the ejection orifices continues for a long period, the ejection heaters enabling desired ejection of the liquid from the ejection orifices. In this technique, multiple ejection heaters (hereinafter, also referred to as first heating resistance elements) are arranged in an array, multiple circulation heaters (hereinafter, also referred to as second heating resistance elements) are arranged in an array, and the arrays are arranged in parallel.

In order to drive the ejection heaters and the circulation heaters, a power supply, drivers (also referred to as drive elements), and drain wiring lines for connecting the drivers to the ejection heaters and the circulation heaters are assumed to be arranged. The drivers for driving the ejection heaters and the drivers for driving the circulation heaters are sometimes arranged on one side in consideration of balance with other circuits. In the above-mentioned technique, multiple supply ports that supply the ink are arranged in an array. The multiple supply ports arranged in an array are used in common. Alternatively, one independent supply port may be provided for each of segment units based on the number of heaters such as the ejection heaters and the circulation heaters, as the supply port that supplies the ink. In the case of the independent supply ports, the drivers and the heaters are arranged on both sides of the independent supply ports. Accordingly, the drain wiring lines only need to be laid out to pass between the independent supply ports.

However, the number of the ejection orifices tends to be on the rise in recent years to achieve printing of higher resolution. As the number of ejection orifices increases, an ink supply amount also tends to increase. As a measure against the increase of the ink supply amount, increasing the size of the independent supply ports is conceivable. However, there is a limit to a usable region on a print element substrate. Accordingly, in the case where the size of the independent supply ports is increased, regions between the independent supply ports become smaller. In the case where the regions between the independent supply ports become smaller, regions usable for passing of the drain wiring lines become smaller.

In the case where the circulation heaters are provided in the print element substrate, the number of drain wiring lines and the number of drivers increase from those in the case where the circulation heaters are not mounted in the print element substrate. For example, in the case where as many circulation heaters as the ejection heaters are arranged, the number of drain wiring lines and the number of the drivers are assumed to be doubled. In such a case, the total number of drain wiring lines increases. Accordingly, in the case where all drain wiring lines including the increased wiring lines are laid out to pass through the regions between the independent supply ports, securing of a wiring width of each drain wiring line as desired may not be possible.

Moreover, in the above-mentioned technique, the ejection heaters consume more energy than the circulation heaters. Accordingly, more energy tends to be consumed in the drain wiring lines that connect the ejection heaters and the drivers configured to drive the ejection heaters to one another than in the drain wiring lines that connect the circulation heaters and the drivers configured to drive the circulation heaters to one another. However, if the energy consumed in the drain wiring lines connected to the ejection heaters can be made smaller than the energy consumed in the drain wiring lines connected to the circulation heaters, efficient drive of the heaters becomes possible.

In the present disclosure, the driver and the drain wiring line for driving each of the ejection heaters and the circulation heaters are configured as follows. Specifically, a print element substrate includes a first drive element array, a second drive element array, a plurality of first wiring lines, and a plurality of second wiring lines. The first drive element array is an array in which a plurality of first drive elements configured to drive a plurality of first heating resistance elements are arranged in an array. The second drive element array is an array in which a plurality of second drive elements configured to drive a plurality of second heating resistance elements are arranged in an array. The plurality of first wiring lines connect the plurality of first heating resistance elements and the plurality of first drive elements to one another. The plurality of second wiring lines connect the plurality of second heating resistance elements and the plurality of second drive elements to one another. The second drive element array is an array that is arranged on the same layer as the first drive element array in parallel to the first drive element array and that is arranged at a position farther away from a heating resistance element region than the first drive element array is on the same layer as the first drive element array, the heating resistance element region being a region in which the plurality of first heating resistance elements and the plurality of second heating resistance elements are arranged. The plurality of second wiring lines are wiring lines formed in a layer different from the plurality of first wiring lines. In such a configuration, it is possible to reduce the energy consumed by the drain wiring lines of the ejection heaters and efficiently drive the heaters while designing the wiring width of the drain wiring lines as desired and securing the size of the drivers. Specifically, the drive elements can be suitably arranged in the print element substrate.

Moreover, according to the present disclosure, laying out the drain wiring lines in two layers doubles the region in which the drain wiring lines can pass between the independent supply ports. Furthermore, designing the wiring width of the drain wiring lines as desired and arranging the drivers in two arrays doubles the region in which the drivers can be arranged. Accordingly, an enough region for arranging the drivers can be secured. Thus, the size of the drivers can be designed as desired.

Moreover, according to the present disclosure, the drivers (also referred to as ejection drive elements) of the ejection heaters are provided in a region closer to the heating resistance element region in which the ejection heaters and the circulation heaters are laid out, than the drivers (also referred to as circulation drive elements) of the circulation heaters are. A resistance value of the drain wiring lines of the ejection heaters can be thereby made smaller than that of the circulation heaters. Accordingly, the energy consumed in the drain wiring lines of the ejection heaters can be made smaller than that of the circulation heaters. Efficient drive of the heaters thereby becomes possible.

The present disclosure is specifically explained below by using the drawings.

### Liquid Ejection Apparatus 50

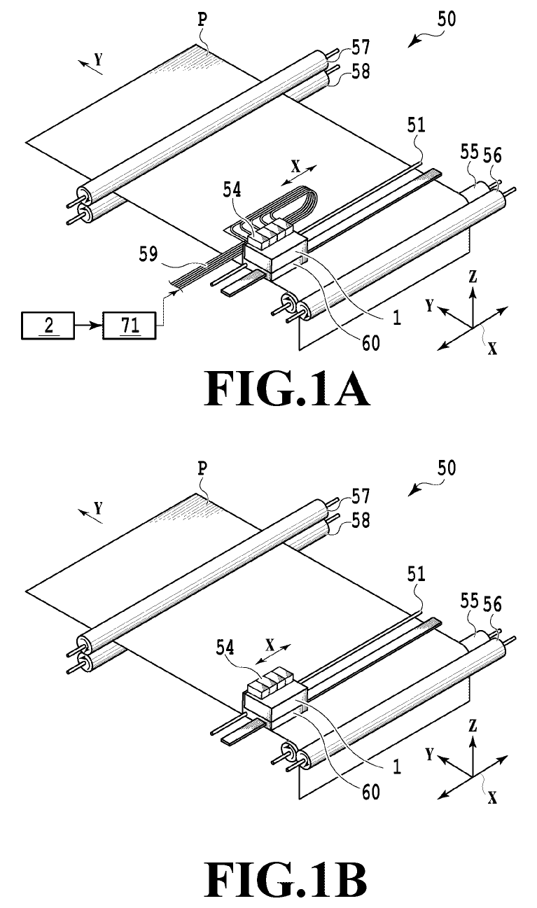

FIG. 1A is a perspective diagram schematically illustrating the liquid ejection apparatus 50 in which ink tanks 2 are provided outside a liquid ejection head 1 as liquid reservoirs. FIG. 1B is a perspective diagram schematically illustrating a liquid ejection apparatus 50 in which ink sub-tanks 54 are provided directly above the liquid ejection head 1. First, portions common to FIGS. 1A and 1B are explained.

The liquid ejection apparatus 50 includes the liquid ejection head 1 and conveyance rollers 55, 56, 57, and 58. The liquid ejection head 1 can perform scanning in a direction X intersecting a conveyance direction Y of an ejection target medium P. The liquid ejection head 1 is mounted in a carriage 60. The liquid ejection head 1 is fixed to and supported on the carriage 60 by not-illustrated positioning means and an electric contact provided in the carriage 60. The carriage 60 is reciprocally moved in a main scanning direction (also referred to as direction X) along a guide shaft 51. Accordingly, the liquid ejection head 1 ejects inks while being moved in the main scanning direction together with the carriage 60 to perform printing on the ejection target medium P. The conveyance rollers 55, 56, 57, and 58 convey the ejection target medium P in a sub scanning direction (also referred to as conveyance direction Y) intersecting (orthogonal to in the present embodiment) the main scanning direction. Specifically, the liquid ejection apparatus 50 is configured as a serial type ink-jet liquid ejection apparatus by ejecting liquid from the liquid ejection head 1 to the ejection target medium P conveyed in the conveyance direction Y while performing scanning of the liquid ejection head 1 in the direction X. Note that application of the present disclosure is not limited to the serial type ink-jet liquid ejection apparatus. The present disclosure can be applied also to a page-wide type ink-jet liquid ejection apparatus that ejects liquid to the ejection target medium P conveyed in the conveyance direction Y by using a line head (page-wide head) elongating in a page width direction of the ejection target medium P. Note that a direction Z indicates the vertical direction in FIGS. 1A and 1B. Specifically, the direction Z is a direction that intersects (orthogonal to in the present embodiment) an X-Y plane specified by the direction X and the conveyance direction Y.

The liquid ejection head 1 can eject four types of inks of black (K), cyan (C), magenta (M), and yellow (Y). The liquid ejection head 1 can print a full-color image by using these four types of inks. Note that the inks that can be ejected from the liquid ejection head 1 is not limited to the four types of inks described above. For example, the present disclosure can be applied also to a liquid ejection head 1 configured to eject other types of inks such as a special color ink. Specifically, the types and the number of the inks ejected from the liquid ejection head 1 are not limited.

Next, portions that differ between FIGS. 1A and 1B are explained. In FIG. 1A, the ink sub-tanks 54 are mounted in the liquid ejection head 1. Four ink supply tubes (liquid communication paths) 59 are attached to the ink sub-tanks 54. Moreover, the liquid ejection apparatus 50 includes the ink tanks 2 and external pumps 71. The ink tanks 2 store the inks. The inks stored in the ink tanks 2 are supplied to the ink sub-tanks 54 via the four ink supply tubes 59 by driving force of the external pumps 71. Meanwhile, in FIG. 1B, the ink sub-tanks 54 are provided directly above the liquid ejection head 1. FIG. 1B is different from FIG. 1A in that, since no ink tanks 2 are provided outside the liquid ejection head 1, no four ink supply tubes 59 are attached, or no external pumps 71 are provided. Note that, in both of FIGS. 1A and 1B, the liquid ejection head 1 may be configured to be provided integrally with the ink sub-tanks 54 and be attachable to or detachable from the carriage 60. Alternatively, the configuration may be such that the ink sub-tanks 54 are provided integrally with the carriage 60, and only the ink sub-tanks 54 can be attached to or detached from the carriage 60. The following explanation is given while using the configuration of FIG. 1A.

### Basic Configuration of Liquid Ejection Head 1

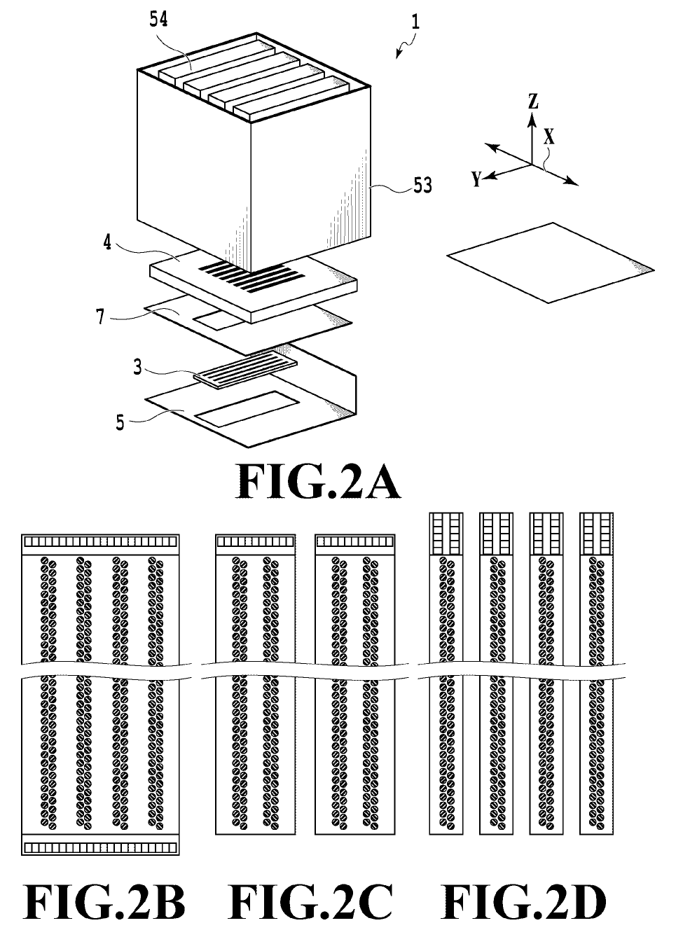

FIGS. 2A to 2D are diagrams illustrating basic configuration examples of the liquid ejection head 1 of FIGS. 1A and 1B. FIG. 2A is an exploded perspective diagram of the liquid ejection head 1 in FIGS. 1A and 1B. FIGS. 2B, 2C, and 2D are diagrams illustrating examples of a liquid ejection chip 3 in FIG. 2A. The liquid ejection head 1 includes a housing portion 53, the ink sub-tanks 54, and the liquid ejection chip 3. The ink sub-tanks 54 temporarily store the inks in the liquid ejection head 1. The ink sub-tanks 54 are housed in the housing portion 53. As described in detail later, the liquid ejection chip 3 is provided in a bottom portion of the housing portion 53. The liquid ejection chip 3 ejects the inks supplied from the ink sub-tanks 54 to the ejection target medium P.

Note that, although omitted in illustration, liquid connector insertion ports are provided on a wall surface of the housing portion 53. Liquid connector provided at front ends of the ink supply tubes 59 in FIG. 1A are inserted and connected to these liquid connector insertion ports in a liquid-tight manner. This configuration forms the ink supply paths extending from the ink tanks 2 to the liquid ejection head 1 via the external pumps 71. In the present embodiment, the four types of inks are used. Accordingly, four sets of the ink tank 2, the external pump 71, the ink supply tube 59, and the ink sub-tank 54 are provided to correspond to the respective inks. Thus, four ink supply paths corresponding to the respective inks are independently formed. As described above, in the present embodiment, the liquid ejection apparatus 50 includes an ink supply system in which the inks are supplied from the ink tanks 2 provided outside the liquid ejection head 1.

A first supporting member 4 and a second supporting member 7 are provided between the housing portion 53 and the liquid ejection chip 3. An electric wiring member 5 is provided below the liquid ejection chip 3. Specifically, ink supply ports and ink collection ports are provided in the first supporting member 4. An opening is provided in the second supporting member 7. The liquid ejection chip 3 is bonded and fixed to the first supporting member 4. The first supporting member 4 is bonded and fixed to the second supporting member 7. The second supporting member 7 holds the electric wiring member 5 such that the electric wiring member 5 is electrically connected to the liquid ejection chip 3. The electric wiring member 5 applies electric signals for ejecting the inks and electric signals for circulating the inks to the liquid ejection chip 3.

Note that, in the present embodiment, the liquid ejection apparatus 50 does not include an ink collection system that collects the inks in the liquid ejection head 1 into the ink tanks 2. Accordingly, the liquid ejection head 1 is provided with the liquid connector insertion ports for connecting the liquid connectors of the ink supply tubes 59, but is not provided with connector insertion ports for connecting tubes configured to collect the inks into the ink tanks 2.

FIG. 2B illustrates a case where the liquid ejection chip 3 has a configuration of one chip per four colors. Specifically, FIG. 2B illustrates a case where the number of colors that can be ejected from one liquid ejection chip 3 is four. The liquid ejection chip 3 includes multiple ejection orifices and pads used for electrical mounting. The four colors are, for example, black, cyan, magenta, and yellow, and arrays are provided separately for the respective colors. Each array is formed along the conveyance direction Y, and the arrays are arranged at intervals along the direction X. Each array includes multiple ejection orifices. Multiple ejection orifices are arranged at equal intervals along the Y direction. The ejection orifices in each array may be arranged in one array along the Y direction without being arranged at intervals in the X direction. Alternatively, the configuration may be such that only the ejection orifices for black are arranged in two arrays, the ejection orifices for the other three colors are arranged in three arrays, and the ejection orifices for the four colors are arranged in a total of five arrays. Note that the liquid ejection chip 3 of FIG. 2A illustrates a configuration example of one chip per four colors. Specifically, the liquid ejection chip 3 of FIG. 2A illustrates one example of the case of FIG. 2B.

FIG. 2C illustrates a case where the liquid ejection chip 3 has a configuration of one chip per two colors. In this case, two chips are used. Specifically, FIG. 2C illustrates a case where the number of colors that can be ejected from one liquid ejection chip 3 is two. In the case where the liquid ejection chip 3 is mounted in the liquid ejection head 1, two liquid ejection chips 3 may be mounted in one liquid ejection head 1, or two liquid ejection heads 1 in each of which one liquid ejection chip 3 is mounted may be prepared.

FIG. 2D illustrates a case where the liquid ejection chip 3 has a configuration of one chip per one color. In this case, four chips are used. Specifically, FIG. 2D illustrates a case where the number of colors that can be ejected from one liquid ejection chip 3 is one. In the case where the liquid ejection chip 3 is mounted in the liquid ejection head 1, four liquid ejection chips 3 may be mounted in one liquid ejection head 1, or four liquid ejection heads 1 in each of which one liquid ejection chip 3 is mounted may be prepared.

Note that, assuming the case where multiple liquid ejection chips 3 are mounted in one liquid ejection head 1 as in FIGS. 2C and 2D, the liquid ejection chips 3 do not have to have the same chip length. Moreover, the number of colors of the liquid ejection chip 3 is not limited to a particular number, and combinations of various numbers of colors may be adopted. For example, although the example in which the number of colors of the liquid ejection chip 3 in FIG. 2A is four is described, the number of colors of the liquid ejection chip 3 may be more than four.

<Individual Channel: Straight Type>

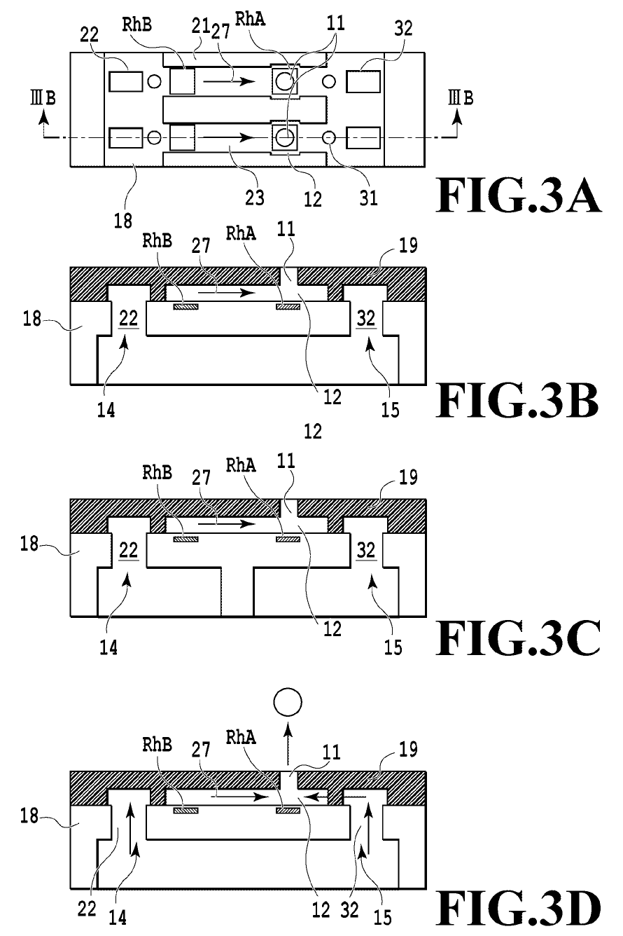

The liquid ejection head 1 includes multiple individual ejection units including individual channels. The liquid ejection head 1 also includes a supply channel for supplying the liquid to the individual channels of the respective individual ejection units. FIG. 3A is a plan diagram as viewed in a direction in which a liquid droplet is ejected from the ejection orifice 11 of the individual ejection unit. FIG. 3B is a IIIB-IIIB cross-sectional diagram of FIG. 3A. FIG. 3C is a IIIB-IIIB cross-sectional diagram of FIG. 3A, and is a cross-sectional diagram in which a configuration inside a print element substrate 18 is different from that in FIG. 3B.

Each of the individual ejection units includes the ejection orifice 11, a pressure chamber 12, a first energy generation element RhA (also referred to as ejection energy generation element RhA), and a second energy generation element RhB (also referred to as circulation energy generation element RhB).

The pressure chamber 12 is formed to correspond to each ejection orifice 11 by partitioning a space between the print element substrate 18 and an orifice plate 19 with a partition 21. The ejection orifice 11 is an opening formed in a portion of the orifice plate 19. A meniscus of the ink flowing through the pressure chamber 12 is formed in the ejection orifice 11, and an ejection orifice interface is formed as an interface between the ink and the atmosphere. The ejection orifice 11 ejects the liquid.

The individual channel 23 extends in a second direction intersecting (orthogonal to in the present embodiment) a direction (first direction) in which the ejection orifices 11 are arranged to form an array. The individual channel 23 includes the pressure chamber 12, an entrance (upstream) side connection channel, and an exit (downstream) side connection channel. The entrance side connection channel communicates with one end portion of the pressure chamber 12. The exit side connection channel communicates with the other end portion of the pressure chamber 12.

A supply port 22 is provided on the one end side of the individual channel 23. The supply port 22 is an opening that extends from a not-illustrated common channel to the upstream side of the individual channel 23 by passing through the inside of the print element substrate 18. A supply port 32 is provided on the other end side of the individual channel 23. The supply port 32 is an opening that extends from the not-illustrated common channel to the downstream side of the individual channel 23 by passing through the inside of the print element substrate 18. The liquid is supplied to the individual channel 23 via the supply port 22 and the supply port 32.

In the print element substrate 18, the first energy generation element RhA is formed closer to the supply port 32 than to the supply port 22. The first energy generation element RhA is an element for generating energy for ejecting the liquid in the pressure chamber 12 from the ejection orifice 11. Specifically, the first energy generation element RhA is driven to generate heat, and causes bubbling of the liquid (also referred to as ink) in the pressure chamber 12. The first energy generation element RhA can thereby eject the ink from the ejection orifice 11 by using this bubble generating energy. An electrothermal transducing element is used as the first energy generation element RhA in the present embodiment. However, the first energy generation element RhA is not limited to a particular element. For example, a piezoelectric element may be used as the first energy generation element RhA.

The second energy generation element RhB is formed closer to the supply port 22 than to the supply port 32 in the print element substrate 18. The second energy generation element RhB is an element that generates energy for causing a circulatory flow of the ink in the individual channel 23 in a direction illustrated by the arrow 27. Although an electrothermal transducing element is used as the second energy generation element RhB in the present embodiment, the second energy generation element RhB is not limited to a particular element. For example, a piezoelectric element may be used as the second energy generation element RhB.

Explanation of a straight type is given. The straight type means that the shape of the individual channel 23 is configured such that both end portions of the individual channel 23 are located on the both sides of the ejection orifice 11, and a direction passing through the both end portions of the individual channel 23 extends in a direction intersecting the direction along the array of the ejection orifices 11 (in a direction orthogonal to the direction along the array of the ejection orifices 11 in the example of FIG. 3A). In other words, in the individual channel 23, the first energy generation element RhA and the second energy generation element RhB are arranged in a direction intersecting the direction along the array of the ejection orifices 11.

Moreover, a supply channel 14 is formed on the second energy generation element RhB side. The supply channel 14 is formed of the supply port 22 and a portion of the individual channel 23 on the second energy generation element RhB side. Meanwhile, a flow-out channel 15 is formed on the first energy generation element RhA side. The flow-out channel 15 is formed of the supply port 32 and another portion of the individual channel 23 on the first energy generation element RhA side.

Next, a flow of the ink flowing in the individual channel 23 is explained. The flow of the ink flowing in the individual channel 23 is categorized into two types. A first ink flow is a flow for refill performed after the liquid ejection apparatus 50 drives the first energy generation element RhA and ejects the ink from the ejection orifice 11. A second ink flow is a flow in which the liquid ejection apparatus 50 drives the second energy generation element RhB to generates a circulatory flow in the direction of the arrow 27.

### First Ink Flow

How the liquid ejection apparatus 50 drives the first energy generation element RhA and ejects the ink from the ejection orifice 11 is illustrated in FIG. 3D. FIG. 3D is a diagram explaining flow-in of the ink in the case where the first energy generation element RhA is driven. In the example of FIG. 3D, the ink is supplied from each of the supply port 22 and the supply port 32 with the ejection of the ink from the ejection orifice 11. Accordingly, the ink flows into the pressure chamber 12 from both of the supply port 22 and the supply port 32.

### Second Ink Flow

Meanwhile, in the case where the liquid ejection apparatus 50 drives the second energy generation element RhB to generate the circulatory flow, the ink flows into the individual channel 23 through the supply port 22, and flows out from the individual channel 23 through the supply port 32. In the present embodiment, the liquid ejection apparatus 50 generates the circulatory flow of the ink in the individual channel 23 in the direction illustrated by the arrow 27 by returning the ink flowing out from the supply port 32 to the supply port 22 to circulate the ink. FIG. 3C illustrates an example in which the supply port 22 and the supply port 32 are formed to become a common channel in the liquid ejection chip 3. FIG. 3D is an example in which each of the supply port 22 and the supply port 32 is provided as an individual channel and the individual channels become a common channel outside the liquid ejection head 1.

The circulatory flow of the ink is further explained. The ink includes solid contents and volatile components such as water. In use of the liquid ejection head 1, there is a case where ejection of the ink from the ejection orifice 11 is destabilized due to evaporation of the volatile components in the ink from the ejection orifice 11, a concentration increase of the solid contents in the ink near the ejection orifice 11 with the evaporation of the volatile components in the ink, and the like. Accordingly, various efforts are made to prevent destabilization of the ejection of the ink from the ejection orifice 11.

For example, a not-illustrated cap member may be provided at a position outside a conveyance path of the ejection target medium P in the X direction. The shape of this cap member is formed in such a shape that the cap member can cover an ejection orifice surface on which the ejection orifices 11 of the liquid ejection head 1 are provided. The cap member can prevent drying of the ejection orifices 11 and protect the ejection orifices 11 by covering the ejection orifice surface on which the ejection orifices 11 of the liquid ejection head 1 are provided, in the case where the liquid ejection head 1 is not performing a printing operation on the ejection target medium P.

Moreover, a not-illustrated ink suction mechanism may be provided. In the case where the cap member and the ink suction mechanism are provided, the cap member is used in cooperation with an ink suction operation from the ejection orifices 11. The ink suction operation refreshes the ink near the ejection orifices 11, thereby an image quality of an obtained image can be maintained.

Furthermore, an ejection operation referred to as preliminary ejection (also referred to as preliminary discharging) is performed in the case where the liquid ejection head 1 is not performing the printing operation on the ejection target medium P. The concentrated ink can be thereby disposed. Moreover, an ejection operation referred to as preliminary ejection (also referred to as paper surface preliminary ejection or in-page preliminary ejection) may be performed in the case where the liquid ejection head 1 is performing the printing operation on the ejection target medium P. The paper surface preliminary ejection or the in-page preliminary ejection is an ejection operation in which the ink of an unnoticeable amount is ejected to a position unnoticeable in terms of image quality on the ejection target medium P. These ejection operations greatly contribute to improving of the image quality of the image, and the ejection orifices 11 are refreshed. Accordingly, part of the ink is disposed. Thus, the waste ink amount may be reduced as much as possible.

For example, the second energy generation element RhB that heats the ink in the individual channel 23 are provided in the print element substrate 18. The circulatory flow of the ink can be thereby generated. This circulatory flow of the ink can suppress drying of the ejection orifices 11 and the concentration increase of the ink near the ejection orifices 11 while suppressing the waste ink amount. From another perspective, the number of times of the preliminary ejection of the ink and the suction of the ink can be minimized. Moreover, minimizing the number of times of the preliminary ejection of the ink can improve throughput and yield of the entire liquid ejection apparatus 50. Note that the second energy generation elements RhB only need to be provided in at least some of the individual channels 23 among the multiple individual channels 23 included in the liquid ejection head 1. This can provide the above-mentioned effects.

Moreover, the liquid ejection head 1 of FIG. 1A may have a configuration in which the second energy generation elements RhB are provided in all portions corresponding to the four types of inks. Alternatively, the liquid ejection head 1 of FIG. 1A may have a configuration in which the second energy generation elements RhB are provided only in portions corresponding to one type of ink. Specifically, the liquid ejection head 1 may have a configuration in which at least one of the multiple types of inks is circulated.

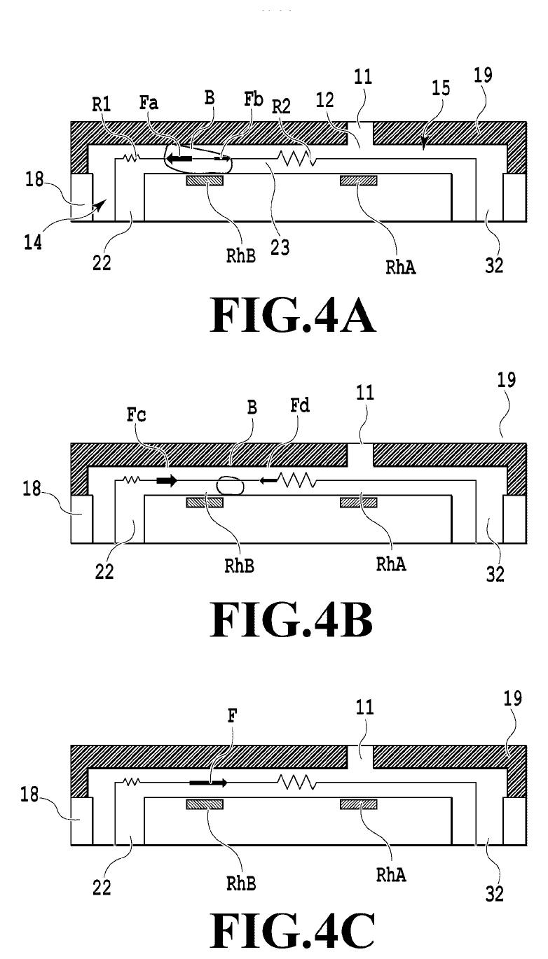

Note that filters 31 as illustrated in FIG. 3A may be provided in the circulation channel of the ink to remove foreign substances included in the ink. The filters 31 are protrusions formed by causing part of the orifice plate 19 to protrude toward the print element substrate 18. In the examples of FIGS. 3A to 3D, the filters 31 are provided at a position on one end side and a position on the other end side of each individual channel 23. In the circulation channel of the ink, the one end side of the individual channel 23 corresponds to the flow-in side of the ink, and the other end side of the individual channel 23 corresponds to the flow-out side of the ink. The filters 31 may be provided at positions between the first energy generation element RhA and the second energy generation element RhB in the individual channel 23. In the case where the filters 31 are provided at positions between the first energy generation element RhA and the second energy generation element RhB in the individual channel 23, the filters 31 do not have to be provided at the position on the one end side and the position on the other end side of the individual channel 23. Next, a principle of ink circulatory flow generation is explained by using FIGS. 4A to 4C.

### Principle of Ink Circulatory Flow Generation

In FIGS. 4A to 4C, illustration of the filters 31 is omitted to facilitate explanation. FIG. 4A is a IIIB-IIIB cross-sectional diagram of the individual ejection unit in FIG. 3A, and is a cross-sectional diagram for explaining a generation and growth process of an air bubble B generated by heating the ink with the second energy generation element RhB and causing film boiling of the ink. FIG. 4B is an IIIB-IIIB cross-sectional diagram of the individual ejection unit in FIG. 3A, and is a cross-sectional diagram for explaining a contraction process of the air bubble B generated by heating the ink with the second energy generation element RhB and causing film boiling of the ink. FIG. 4C is a IIIB-IIIB cross-sectional diagram of the individual ejection unit in FIG. 3A, and is a cross-sectional diagram for explaining a process after disappearing of the air bubble B generated by heating the ink with the second energy generation element RhB and causing film boiling of the ink. Next, the generation and growth process, the contraction process, and the process after the disappearing of the air bubble B are explained.

### Generation and Growth Process of Air Bubble B

As illustrated in FIG. 4A, the second energy generation element RhB is arranged at a position closer to the supply port 22 out of the supply port 22 and the supply port 32. Accordingly, a flow resistance R1 generated in a channel between the second energy generation element RhB and the supply port 22 in response to generation of circulatory flow of the ink is smaller than a flow resistance R2 generated in a channel between the second energy generation element RhB and the supply port 32. Thus, as illustrated in FIG. 4A, a difference between the flow resistance R1 and the flow resistance R2 causes the air bubble B generated by the film boiling of the ink to grow while being biased toward the channel of the relatively-smaller flow resistance R1. A flow vector Fa of the ink flowing toward the channel on the side where the flow resistance R1 is generated is thus larger than a flow vector Fb of the ink flowing toward the channel on the side where the flow resistance R2 is generated. Note that a circuit including the flow resistances R1 and R2 is equivalent to a circuit in which the flow resistances generated by the circulatory flow of the ink in a channel including the individual channel 23 are expressed by an analogy to electric resistances.

### Contraction Process of Air Bubble B

In the contraction process of the air bubble B, the ink flows in to fill a volume corresponding to contraction of the air bubble B. In this case, as illustrated in FIG. 4B, a flow vector Fc of the ink flowing in from the supply port 22 on the flow resistance R1 side is larger than a flow vector Fd of the ink flowing in from the supply port 32 on the flow resistance R2 side. Moreover, the disappearing position of the air bubble B is shifted from the position above the second energy generation element RhB to a portion of the channel closer to the supply port 32.

### Process after Disappearing of Air Bubble B

As explained by using FIG. 4B, a relationship of Fc>Fd is established. Accordingly, a flow vector F of the circulatory flow of the ink from the supply port 22 toward the supply port 32 is generated. The magnitude of the flow vector F is affected by a ratio between the flow resistances R1 and R2 and the size of the air bubble B. For example, assume a case where the second energy generation element RhB is used. In this case, an arrangement position of the second energy generation element RhB is preferably closer to one of both end portions of the individual channel 23 than to an arrangement position of the first energy generation element RhA. Specifically, the flow resistance ratio R1/R2 is preferably set in a range of 0.05 to 0.40. Setting the flow resistance ratio R1/R2 in the range of 0.05 to 0.40 allows the flow vector F of the circulatory flow of the ink to be set at a local maximum value. Increasing the flow vector Fa of the ink and increasing the flow vector Fc of the ink increases the flow vector F of the circulatory flow of the ink, and increases the circulatory flow of the ink. Accordingly, it is preferable to reduce the flow resistance R1 as much as possible. Moreover, it is preferable to reduce the flow vector Fb of the ink as much as possible and reduce the flow vector Fd of the ink. Accordingly, it is preferable to increase the flow resistance R2. In view of this, it is preferable to reduce the flow resistance R1 and increase the flow resistance R2. Specifically, reducing the flow resistance ratio R1/R2 is preferable. Moreover, the air bubble B being large, that is the volume of the air bubble B being large leads to an increase of a fluid displacement volume in the individual channel 23, and thus leads to an increase of the circulatory flow. For example, following elements can be given as elements that contribute to the increase of the circulatory flow. The elements that contribute to the increase of the circulatory flow include increasing the size of the second energy generation element RhB. Moreover, the elements that contribute to the increase of the circulatory flow include increasing the width and the height of the channel on the supply port 22 side and reducing the flow resistance R1 relative to the flow resistance R2. Furthermore, the elements that contribute to the increase of the circulatory flow include reducing the viscosity of the ink. Moreover, the elements that contribute to the increase of the circulatory flow include configuring the liquid ejection head 1 as a double-pulse. Configuring the driving pulse as a double-pulse means as follows. First, a short pulse of such a level that the pulse does not generate an air bubble in a portion of the channel above the second energy generation element RhB is applied to the second energy generation element RhB to heat the ink around the portion of the channel above the second energy generation element RhB. Then, a main pulse that generates the air bubble for the circulation of the ink is applied to the second energy generation element RhB to grow a large air bubble.

Moreover, part of the ink made to flow by the circulatory flow of the ink enters an inside of the ejection orifice 11. This causes the concentrated ink in the ejection orifice 11 to be sent out to the channel on the supply port 32 side, and causes the fresh ink to flow into the ejection orifice 11 from the channel on the supply port 22 side through the individual channel 23. Accordingly, the concentrated ink is less likely to stagnate in the ejection orifice 11. Thus, it is possible to maintain an initial ink ejection state while suppressing effects of the concentrated ink.

The circulatory flow of the ink is a transitional flow generated with the growth process and the contraction process in the case where the air bubble B is generated. Accordingly, after the disappearing of the air bubble B, the inertial circulatory flow of the ink decays over time, and stops after a certain time period. Hence, in order to regularly generate the circulatory flow over a certain time period, the second energy generation element RhB is preferably, repeatedly driven. Note that a driving cycle of the second energy generation element RhB is not limited to a particular cycle, and it is only necessary that the concentrated ink stagnating in the ejection orifice 11 can be discharged. Note that the circulatory flow of the ink is a transitional flow generated with the growth process and the contraction process in the case where the air bubble B is generated. Accordingly, in the case where the second energy generation element RhB is driven at a high driving frequency such as about 100 kHz in consideration of a cycle of 10 μs that is a time period from generation to disappearing of the air bubble B, a phenomenon in which promotion of the circulatory flow of the ink is hindered may occur. Accordingly, it is preferable to drive the second energy generation element RhB at a driving cycle of, for example, about 100 Hz to several tens of kHz.

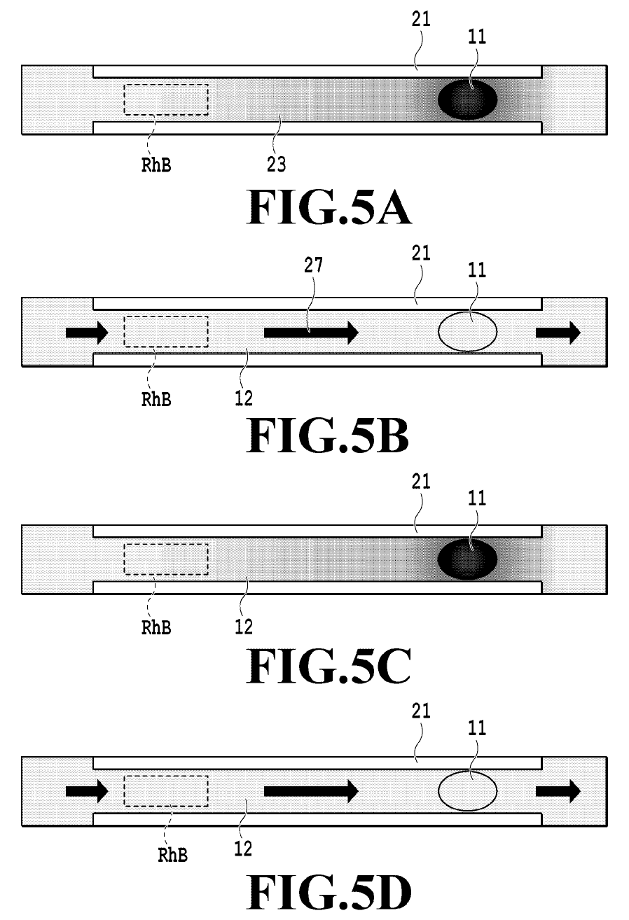

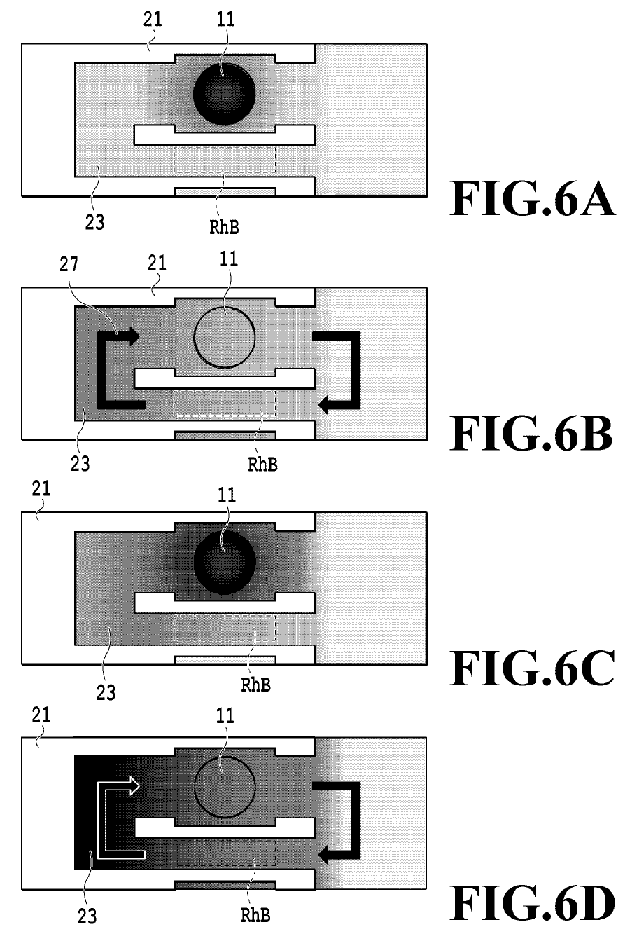

Specifically, the higher the driving frequency of the second energy generation element RhB is, the more the circulatory flow of the ink is maintained. Accordingly, the effect of discharging the concentrated ink attributable to the circulatory flow of the ink increases. However, it is assumed that the higher the driving frequency of the second energy generation element RhB is, the more the temperature increase of the ink caused by the heat generation of the second energy generation element RhB attributable to the drive of the second energy generation element RhB is. Accordingly, it is preferable to appropriately control the number of driving times the second energy generation element RhB. Next, elimination of an ink concentration increase with the circulatory flow of the ink is explained by using FIGS. 5A to 5D and 6A to 6D.

### Elimination of Ink Concentration Increase; Straight Type

FIG. 5A is a diagram illustrating a state where the circulatory flow of the ink is temporarily paused. FIG. 5B is a diagram illustrating a state immediately after generation of the circulatory flow of the ink performed by driving the second energy generation element RhB after the state of FIG. 5A. FIG. 5C is a diagram illustrating a state where the circulatory flow of the ink is temporarily paused after the state of FIG. 5B. FIG. 5D is a diagram illustrating a state immediately after generation of the circulatory flow of the ink performed by driving the second energy generation element RhB after the state of FIG. 5C. As illustrated in FIGS. 5A to 5D, the straight type individual channel 23 has a configuration in which the entrance and the exit of the circulatory flow of the ink are separated from each other. Note that the ink in the individual channel 23 is hatched in a dot pattern, and the density of the dot pattern hatching is increased in a portion where the ink is concentrated to express a level of the ink concentration increase.

As illustrated in FIG. 5A, in the state where the circulatory flow of the ink is temporarily paused, the volatile components of the ink evaporate from the ejection orifice 11. Accordingly, the ink concentration increase progresses near the ejection orifice 11. Then, in the case where the second energy generation element RhB is driven, the circulatory flow of the ink is resumed. As a result, as illustrated in FIG. 5B, the ink concentration increase progressing near the ejection orifice 11 is eliminated. Then, in the case where the circulatory flow of the ink is temporarily paused, as illustrated in FIG. 5C, the ink concentration increase progresses again near the ejection orifice 11 as in FIG. 5A. Thereafter, in the case where the second energy generation element RhB is driven, the circulatory flow of the ink is resumed. As a result, as illustrated in FIG. 5D, the ink concentration increase progressing near the ejection orifice 11 is eliminated as in FIG. 5B. Accordingly, the ink concentration increase is eliminated in the entire individual channel 23. As described above, in the straight type individual channel 23, the ink concentration increase state is reset every time the temporary pausing and the resume of the circulatory flow of the ink are repeated.

### Elimination of Ink Concentration Increase; U-shape Type

FIG. 6A is a diagram illustrating a state where the circulatory flow of the ink is temporarily paused. FIG. 6B is a diagram illustrating a state immediately after generation of the circulatory flow of the ink performed by driving the second energy generation element RhB after the state of FIG. 6A. FIG. 6C is a diagram illustrating a state where the circulatory flow of the ink is temporarily paused after the state of FIG. 6B. FIG. 6D is a diagram illustrating a state immediately after generation of the circulatory flow of the ink performed by driving the second energy generation element RhB after the state of FIG. 6C. As illustrated in FIGS. 6A to 6D, the U-shape type individual channel 23 has a configuration in which the entrance and the exit of the circulatory flow of the ink are adjacent to one another. Note that the ink in the individual channel 23 is hatched in a dot pattern, and the density of the dot pattern hatching is increased in a portion where the ink is concentrated to express the level of the ink concentration increase.

As illustrated in FIG. 6A, in the state where the circulatory flow of the ink is temporarily paused, the volatile components of the ink evaporate from the ejection orifice 11. Accordingly, the ink concentration increase progresses near the ejection orifice 11. Then, in the case where the second energy generation element RhB is driven, the circulatory flow of the ink is resumed. As a result, the state illustrated in FIG. 6B is established. The entrance of the individual channel 23 in FIG. 6A and the exit of the individual channel 23 in FIG. 6A are adjacent to each other. Accordingly, the ink concentrated near the ejection orifice 11 is discharged from the exit of the individual channel 23, but part of the discharged ink flows into the individual channel 23 again from the entrance of the individual channel 23. Accordingly, a phenomenon in which the ink in the entire individual channel 23 is not replaced by the fresh ink, and is replaced by slightly concentrated ink (hereinafter, this phenomenon is referred to as recirculation concentration increase) occurs. Then, in the case where the circulatory flow of the ink is temporarily paused, as illustrated in FIG. 6C, the ink concentration increase progresses again near the ejection orifice 11 from the state of FIG. 6B as in FIG. 6A. Thereafter, in the case where the second energy generation element RhB is driven, the circulatory flow of the ink is resumed. As a result, as illustrated in FIG. 6D, the ink in the entire individual channel 23 is replaced by the ink further concentrated from that in FIG. 6B due to the effect of the recirculation concentration increase. As described above, in the U-shape individual channel 23, the ink concentration increase state is not reset every time the temporary pausing of the circulatory flow of the ink and the circulation operation are repeated, and the ink concentration increase gradually progresses in the entire individual channel 23. Accordingly, ink concentration increase state becomes more severe. Moreover, assume a case where the temporary pausing and the resume of the circulatory flow of the ink are not repeated. Also in this case, if a temporary pausing period of the circulatory flow of the ink is long and the ink concentration increase near the ejection orifice 11 progresses, an effect of improving the ink concentration increase state of the ink is less likely to be obtained even in the first resuming of the circulatory flow of the ink. The reason for this is because the effect of improving the ink concentration increase state is small due to the recirculation concentration increase.

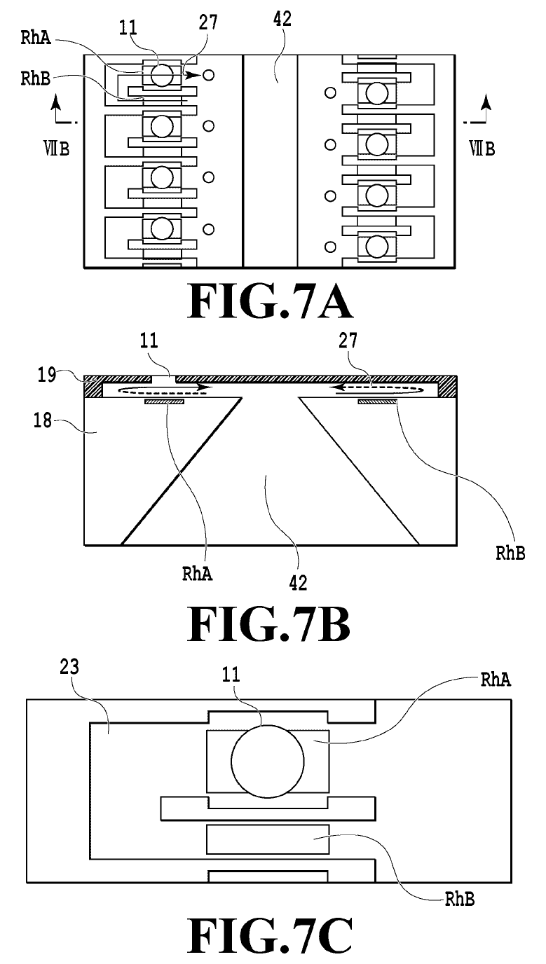

Accordingly, the straight type individual channel 23 and the U-shape type individual channel 23 differ from each other in the effect of the discharged concentrated ink, and this causes a difference in the effect of eliminating the ink concentration increase state by the temporary pausing and the resume of the circulatory flow of the ink. Specifically, in the case of the straight type individual channel 23, the ink concentration increase state including the entire individual channel 23 is more likely to be eliminated. Meanwhile, in the case of the U-shape type individual channel 23, the ink concentration increase state including the entire individual channel 23 is less likely to be eliminated due to the recirculation concentration increase. Accordingly, in the case of the U-shape type individual channel 23, the ejection of the ink may become unstable depending on a degree of concentration increase in the entire individual channel 23. Next, a configuration of a portion of the U-shape type individual channel 23 near the ejection orifice 11 is explained by using FIGS. 7A to 7C.

### Configuration of Portion of U-shape Type Individual Channel 23 near Ejection orifice 11

FIG. 7A is a plan diagram as viewed in the direction in which the liquid droplet is ejected from the ejection orifice 11. FIG. 7B is a VIIB-VIIB cross-sectional diagram of FIG. 7A. FIG. 7C is an enlarged schematic diagram of the individual channel 23 in FIG. 7A.

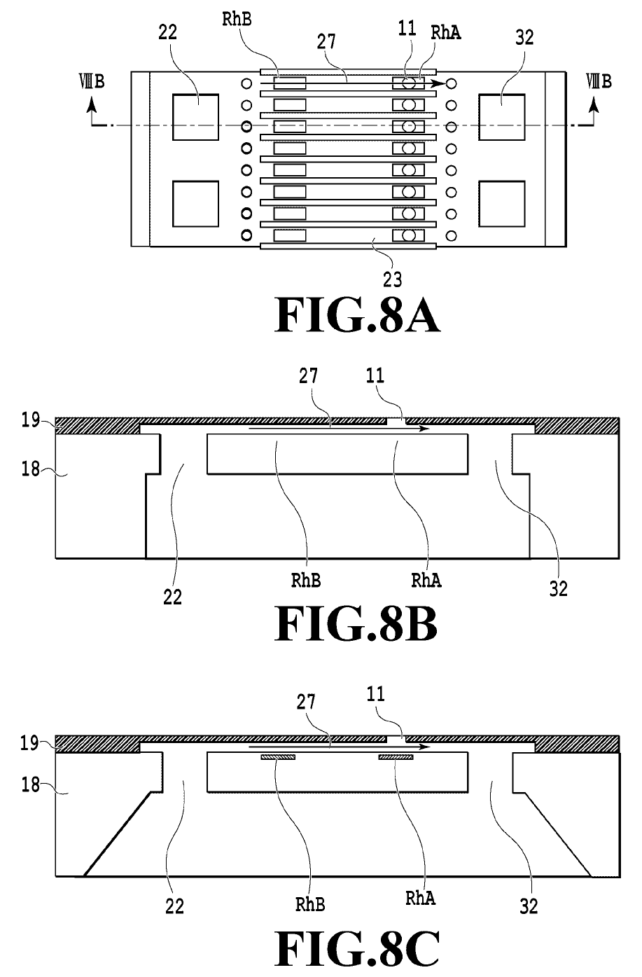

In FIGS. 7A and 7B, each of the ejection orifices 11 is an opening portion formed in a portion of the orifice plate 19. In the print element substrate 18, the first energy generation element RhA is formed at a position directly below and corresponding to each ejection orifice 11. The second energy generation element RhB is also formed in the print element substrate 18. The second energy generation element RhB generates the circulatory flow of the ink in the direction illustrated by the arrow 27 in the channel including the individual channels 23. A supply groove 42 is formed in the direction along the arrays of the ejection orifices 11, between the arrays of the first energy generation elements RhA and the arrays of the second energy generation elements RhB in the print element substrate 18 to penetrate print element substrate 18. The supply groove 42 communicates with the individual channels 23, and can supply the ink to the individual channels 23. As described above, the configuration is not limited to the configuration provided with multiple independent supply openings like the supply ports 22 and the supply ports 32 in FIGS. 3A to 3D, and the liquid may be made to flow in and out by using a large opening like the common supply groove 42 in FIGS. 7A to 7C. Next, a configuration of a portion of the straight type individual channel 23 near the ejection orifice 11 is explained by using FIGS. 8A to 8C.

### Configuration of Portion of Straight Type Individual Channel 23 near Ejection orifice 11

FIG. 8A is a plan diagram as viewed in the direction in which the liquid droplet is ejected from the ejection orifice 11. FIG. 8B is a VIIIB-VIIIB cross-sectional diagram of FIG. 8A. FIG. 8C is a VIIIB-VIIIB cross-sectional diagram of FIG. 8A, and is a cross-sectional diagram in which the configuration inside the print element substrate 18 is different from that in FIG. 8B. FIGS. 8B and 8C illustrate two examples that differ from each other in the shape of the back side of the print element substrate 18 depending on a type of etching method applied to the print element substrate 18, and the shape of the back side of the print element substrate 18 may be either shape. Specifically, the configuration inside the print element substrate 18 may be any configuration.

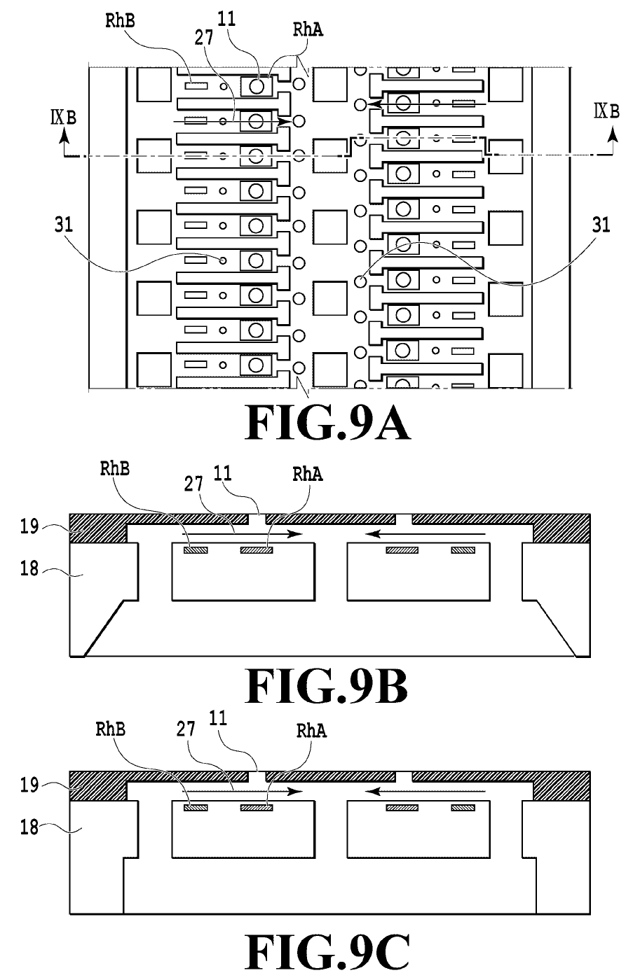

The present configuration is different from the configuration of the portion of the U-shape type individual channel 23 near the ejection orifice 11 in that the individual channel 23 has the straight type configuration in which the entrance and the exit of the individual channel 23 are not adjacent to each other as in the U-shape type individual channel 23, and are separated from each other. Moreover, the direction connecting both ends of the straight type individual channel 23 is orthogonal to the direction in which the ejection orifices 11 are arranged to form an array as illustrated in FIG. 8A. Adopting such an arrangement configuration causes the position where the circulatory flow of the ink flows into the individual channel 23 and the position where the circulatory flow of the ink flows out from the individual channel 23 to be separated from each other. Accordingly, it is possible to suppress the concentrated ink in the ejection orifice 11 from flowing into the individual channel 23 again. The effect of the ink concentration increase can be thereby suppressed. Next, another configuration of the portion of the straight type individual channel 23 near the ejection orifice 11 is explained by using FIGS. 9A to 9C.

### Another Configuration of Portion of Straight Type Individual Channel 23 near Ejection orifice 11

FIG. 9A is a plan diagram as viewed in the direction in which the liquid droplet is ejected from the ejection orifice 11. FIG. 9B is a IXB-IXB cross-sectional diagram of FIG. 9A. FIG. 9C is a IXB-IXB cross-sectional diagram of FIG. 9A, and is a cross-sectional diagram in which the configuration inside the print element substrate 18 is different from that in FIG. 9B. FIGS. 9B and 9C illustrate two examples that differ from each other in the shape of the back side of the print element substrate 18 depending on the type of etching method applied to the print element substrate 18, and the shape of the back side of the print element substrate 18 may be either shape. Specifically, the configuration inside the print element substrate 18 may be any configuration. Moreover, illustration of the filters 31 is omitted in FIGS. 9B and 9C. Furthermore, the present configuration is different from that in FIGS. 8A to 8C in that the number of ink supply opening arrays is increased by one from two to three. The number of arrays of the ejection orifices 11 can be thereby doubled, and the arrays of the ejection orifices 11 can be arranged on the sides close to the center ink supply openings. Specifically, the arrays of the ejection orifices 11 are arranged in the array direction of the multiple ink supply openings at the center, on both sides of the multiple ink supply openings. This arrangement can increase the number of the ink supply opening arrays by one from two to three, and double the number of arrays of the ejection orifices 11 from one to two. Moreover, as illustrated in FIG. 9A, the two arrays of the ejection orifices 11 can be arranged with pitches of the respective two arrays of the ejection orifices 11 shifted from each other. Furthermore, it is possible not to include wiring regions between the supply openings in the center ink supply opening array. Accordingly, this configuration has high degrees of freedom in terms of resolution and the size of the openings in the center ink supply opening array. This configuration enables quick refill into the ejection orifices 11, and can handle high productivity. Note that the positions of the ejection orifices 11 and the positions of the ink supply openings can be shifted to suit routing of wiring lines. Next, the ink according to the present embodiment is explained.

### Ink

As explained above, although the level of eliminating the ink concentration increase differs based on the difference in the configuration of the channel including the individual channel 23, the following effects can be provided by generating the circulatory flow of the ink in the individual channel 23 with the second energy generation element RhB. Specifically, the effects of the concentrated ink thickened due to evaporation of the volatile components in the ink in the ejection orifice 11 can be suppressed. Accordingly, the ejection state of the ink can be maintained at an excellent level, and effects of a change in ink ejection speed can be further reduced. Thus, ejection of the ink can be stabilized.

Meanwhile, use of an ink with a different type of ink color material, a different content amount of ink solid contents, and the like is conceivable depending on the application of the liquid ejection head 1 or the liquid ejection apparatus 50 in which the liquid ejection head 1 is mounted. Specifically, capability of the liquid ejection head 1 is preferably such that the liquid ejection head 1 can maintain ink ejection stability regardless of the type of used ink.

For example, as a case resulting from water in the ink, there is a case where changes such as curling (also referred to as warping) and cockling (also referred to as corrugating wrinkles) may occur in a plain paper. In such a case, use of an ink with a reduced water amount is conceivable. Moreover, in an ink with a low water amount, concentrations of an organic solvent other than water and the solid contents of the ink such as pigment and resin are high. Accordingly, the viscosity of the ink tends to rapidly increase with evaporation of water in the ink. Hence, the ink with low water amount tends to cause a decrease of ink ejection stability. In view of this, in the case where the ink with low water amount is used, an increase in the viscosity of the ink can be suppressed by generating the circulatory flow of the ink in the channel configuration including the individual channel 23 as in the present embodiment. Generally, an ink with a large amount of solid contents has 10 wt% of solid contents. Specifically, the present embodiment is preferably applied to an ink in which a content amount of solid contents contained in the ink is 10 wt% (also referred to as mass%) or more.

A relationship between an operation temperature of the liquid ejection head 1 and the viscosity of the ink is explained. There is a case where the second energy generation elements RhB arranged in the entire liquid ejection chip 3 are driven and controlled to heat the liquid ejection head 1 until the temperature of the liquid ejection head 1 reaches a certain temperature, and the liquid ejection head 1 is used. The viscosity of the ink changes depending on the temperature of the ink. Accordingly, the viscosity of the ink at the operation temperature of the liquid ejection head 1 affects the ejection stability of the ink.

A relationship between a circulatory flow rate of the ink and a driving frequency of each of the first energy generation elements RhA and the second energy generation elements RhB is explained. In the case where the circulatory flow of the ink is generated by the second energy generation elements RhB, it is possible to achieve a circulatory flow rate in which an instant flow rate of the ink is several tens of mm/s to 1,000 mm/s. An average flow rate as viewed in a time width in the order of several hundred μs depends on the driving frequency of the second energy generation elements RhB. The reason for this is as follows. In the case where the circulatory flow of the ink is generated by the second energy generation elements RhB, the circulatory flow of the ink is a transitional circulatory flow that decays over time and stops after a certain time period. Meanwhile, in the case where the circulatory flow of the ink is generated by the first energy generation elements RhA, drive at a frequency of about 10 to 20 kHz that is about the same level as the driving frequency (also referred to as ejection frequency) of the first energy generation elements RhA is possible. In this case, the average flow rate of the circulatory flow of the ink can be several mm/s to 100 mm/s. Next, a relationship between a pigment concentration and the elimination of the ink concentration increase is explained.

### Ink with High Pigment Concentration

A case of an ink with a high pigment concentration is explained. For example, in the case where an ink with such a concentration that the viscosity of the ink at the operation temperature of the liquid ejection head 1 is 3 cP or more and 6 cP or less is used, thickening of the ink tends to progress near the ejection orifices 11 depending on a non-ejection time period of the ink (also referred to as paused time period of the circulatory flow of the ink). Accordingly, a change in the ink ejection speed tends to occur. Hence, a decrease in the ink ejection stability tends to occur. In order to suppress the decrease of the ink ejection stability, it is preferable to generate a certain circulation amount of the ink while the paused time period of the circulatory flow of the ink is short and circulate the ink. Accordingly, performing regular circulation of the ink or performing transitional circulation of the ink at high frequency is preferable to eliminate the concentration increase of the ink. The transitional circulation of the ink can be performed by driving the second energy generation elements RhB. Driving the second energy generation elements RhB and resuming the circulatory flow of the ink at high frequency from the paused state of the circulatory flow of the ink can contribute to elimination of the concentration increase of the ink near the ejection orifices 11.

### Ink with Low Pigment Concentration

A case of an ink with a low pigment concentration is explained. For example, in the case where an ink with such a concentration that the viscosity of the ink at the operation temperature of the liquid ejection head 1 is 1 cP or more and 2 cP or less is used, thickening of the ink may progress near the ejection orifices 11 depending on the non-ejection time period of the ink (also referred to as paused time period of the circulatory flow of the ink). Accordingly, a change in the ink ejection speed may occur, but is smaller than that in the high-concentration ink. Meanwhile, in the case where the paused time period of the circulatory flow of the ink is long, for example, the thickening of the ink near the ejection orifices 11 may progress depending on a non-print drive time period (also referred to as stopped time period). Accordingly, in the case where the liquid ejection head 1 is stopped without performing printing for a certain time period and then made to restart, it is preferable to execute a recovery process involving waste ink such as a suction operation of the ink, a wipe operation, or preliminary ejection in which these operations are combined. Performing drive of the second energy generation elements RhB to resume the circulatory flow of the ink as the recovery operation can contribute to elimination of the ink concentration increase near the ejection orifices 11 without generation of the waste ink. Moreover, it is possible to avoid generation of the waste ink by driving the second energy generation elements RhB and performing a recovery process enough to resume the circulatory flow of the ink depending on the stop time period. Alternatively, it is possible to perform a recovery process in which the waste ink is minimized by combining a suction operation for removing the air bubble B in the liquid ejection head 1 separate from the elimination of the ink concentration increase while resuming and recovering the circulatory flow of the ink.

### More Appropriate Configuration for Elimination of Ink Concentration Increase

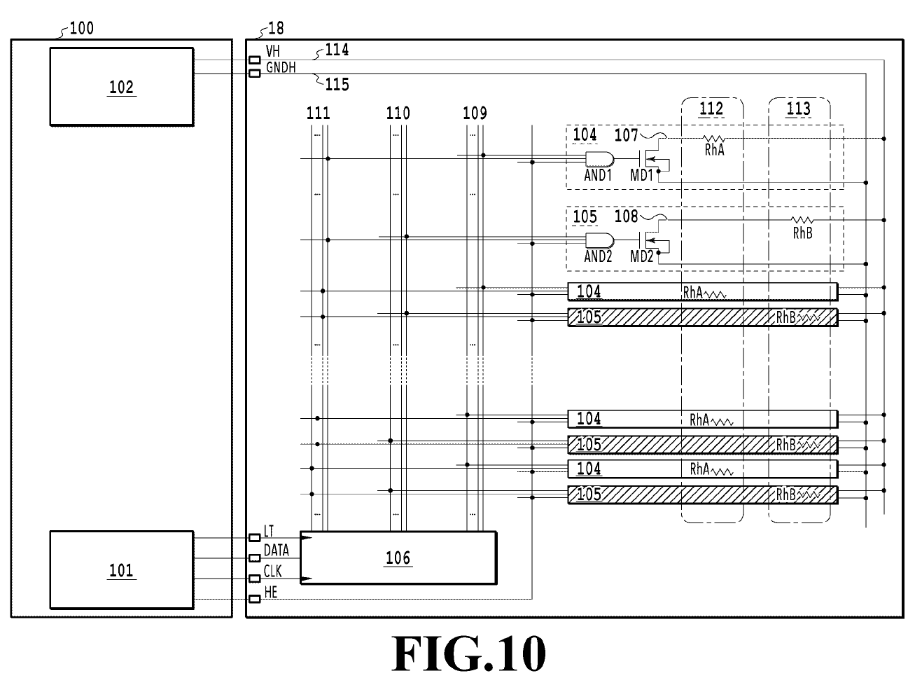

As explained above, in order suppress the effects of the concentrated ink, it is preferable to replace the concentrated ink to the initial fresh ink as much as possible for both of the high-concentration ink and the low-concentration ink. Accordingly, in the case where the second energy generation elements RhB are driven, the lower the effect of the recirculation concentration increase is, the higher the obtained circulation effect is. Specifically, a higher circulation effect can be obtained in the configuration of the straight type individual channel 23 than in the configuration of the U-shape type individual channel 23. Next, an electric circuit configuration that drives and controls the first energy generation elements RhA and the second energy generation elements RhB according to the present embodiment is explained by using FIGS. 10 to 17.

### Heater Selection Circuit

FIG. 10 is a diagram illustrating a circuit configuration example of the print element substrate 18 according to the present embodiment. Various signals are supplied from a main PCB 100 to the print element substrate 18. The main PCB 100 includes a power circuit 102 and a controller 101. The power circuit 102 applies a power supply voltage to the print element substrate 18 via a power supply voltage wiring line VH. The power circuit 102 and the print element substrate 18 are connected to each other via a GNDH wiring line 115. The GNDH wiring line 115 is included in a ground wiring layer. A reference potential of the print element substrate 18 is set by the ground wiring layer. Accordingly, the GNDH wiring line 115 functions as the reference potential of the print element substrate 18. The controller 101 is formed mainly of a ROM, a RAM, and a CPU, and supplies various electric signals to the print element substrate 18. The controller 101 is connected to the print element substrate 18 via an enable signal line HE, a latch signal line LT, a data signal line DATA, and a clock signal line CLK. The controller 101 supplies an enable signal via the enable signal line HE. The enable signal is a signal that controls a time period in which an element to be controlled is set to an on state and a current flows to the element, based on a pulse width. The enable signal is a signal for performing adjustment such that more desirable thermal energy generation can be performed by taking into consideration manufacturing errors of heater resistance values in the print element substrate 18, manufacturing errors of the power circuit 102, and voltage drop of power supply wiring lines that occurs in the case where multiple heaters are simultaneously driven. In the present embodiment, explanation is given of an example in which the enable signal line HE is shared between ejection and circulation to reduce the number of signal terminals. However, providing individual enable signal lines HE for ejection and circulation allows different pulse widths to be set for ejection and circulation. Note that, in the present embodiment, the configuration is as follows assuming that the enable signal line HE is shared between ejection and circulation. Specifically, it is preferable that the ejection heaters RhA and the circulation heaters RhB are formed in an identical step of a semiconductor manufacturing process, and the pulse width of the enable signal is adjusted assuming that the heaters have the same manufacturing errors (same resistance value deviation amount with respect to an ideal value). The controller 101 supplies a latch signal to the print element substrate 18 via the latch signal line LT. The controller 101 supplies a data signal to the print element substrate 18 via the data signal line DATA. The controller 101 supplies a clock signal to the print element substrate 18 via the clock signal line CLK.

The print element substrate 18 includes multiple ejection modules 104 and multiple circulation modules 105. Each ejection module 104 includes an ejection heater RhA, an ejection drive element MD1, and an ejection logic circuit AND1. The ejection heater RhA is the ejection energy generation element. The first energy generation element RhA is also the ejection energy generation element. In other words, the ejection heater RhA and the first energy generation element RhA refer to the same element. These terms are selectively used depending on whether the element is a circuit element or an element arranged in the structure of the individual channel 23. The ejection heater RhA, the first energy generation element RhA, and the ejection energy generation element are collectively referred to as a first heating resistance element. The ejection drive element MD1 (also referred to as first drive element) is an element for causing a current to flow in the ejection heater RhA. The ejection logic circuit AND1 is an element for selectively driving the ejection drive element MD1 included in a corresponding one of the multiple ejection modules 104. The print element substrate 18 generates heat by causing the current to flow in the ejection heater RhA. The ink is thereby made to bubble and is ejected. Accordingly, printing can be performed on the ejection target medium P. Moreover, in the present embodiment, an ejection heater array 112 is formed by arranging multiple ejection heaters RhA in an array.

Assume that each ejection drive element MD1 is formed of a metal-oxide-semiconductor field effect transistor (MOSFET). In the example of FIG. 10, a source terminal of the ejection drive element MD1 and the GNDH wiring line 115 are connected to each other. Moreover, a gate terminal of the ejection drive element MD1 and the output side of the ejection logic circuit AND1 are connected to each other. Furthermore, a drain terminal of the ejection drive element MD1, the ejection heater RhA, and the power supply voltage wiring line VH are connected to one another. The drain terminal of the ejection drive element MD1 and the ejection heater RhA are connected to each other via an ejection drain wiring line 107. In the case where a gate drive voltage is applied between the gate terminal and the source terminal of the ejection drive element MD1 in response to a signal outputted from the ejection logic circuit AND1, the following matters occur. Specifically, a driving current flows to the ejection heater RhA via the ejection drain wiring line 107. The ejection heater RhA thereby generates heat. Accordingly, the ink is made to bubble and is ejected, and printing on the ejection target medium P becomes possible. Note that the ejection drive element MD1 may be formed of an element other than the MOSFET. For example, the ejection drive element MD1 may be formed of a bipolar transistor. Alternatively, the ejection drive element MD1 may be formed of an insulated gate bipolar transistor (IGBT).

Each circulation module 105 includes a circulation heater RhB, a circulation drive element MD2, and a circulation logic circuit AND2. The circulation heater RhB is the circulation energy generation element. The second energy generation element RhB is also the circulation energy generation element. In other words, the circulation heater RhB and the second energy generation element RhB refer to the same element. These terms are selectively used depending on whether the element is the circuit element or the element arranged in the structure of the individual channel 23. The circulation heater RhB, the second energy generation element RhB, and the circulation energy generation element are collectively referred to as a second heating resistance element. The circulation drive element MD2 (also referred to as second drive element) is an element for causing a current to flow in the circulation heater RhB. The circulation logic circuit AND2 is an element for selectively driving the circulation drive element MD2 included in a corresponding one of the multiple circulation modules 105. The print element substrate 18 generates heat by causing the current to flow in the circulation heater RhB. The air bubble B of the ink thereby grows, and can generate the circulatory flow in the channel of the ink including the individual channel 23. Moreover, in the present embodiment, a circulation heater array 113 is formed by arranging multiple circulation heaters RhB in an array.

Assume that each circulation drive element MD2 is formed of a metal-oxide-semiconductor field effect transistor (MOSFET). In the example of FIG. 10, a source terminal of the circulation drive element MD2 and the GNDH wiring line 115 are connected to each other. Moreover, a gate terminal of the circulation drive element MD2 and the output side of the circulation logic circuit AND2 are connected to each other. Furthermore, a drain terminal of the circulation drive element MD2, the circulation heater RhB, and the power supply voltage wiring line VH are connected to one another. The drain terminal of the circulation drive element MD2 and the circulation heater RhB are connected to each other via a circulation drain wiring line 108. In the case where a gate drive voltage is applied between the gate terminal and the source terminal of the circulation drive element MD2 in response to a signal outputted from the circulation logic circuit AND2, the following matters occur. Specifically, a driving current flows to the circulation heater RhB via the circulation drain wiring line 108. The circulation heater RhB thereby generates heat. Accordingly, the air bubble B of the ink grows, and the circulatory flow is generated as explained above. Note that the circulation drive element MD2 may be formed of an element other than the MOSFET. For example, the circulation drive element MD2 may be formed of a bipolar transistor. Alternatively, the circulation drive element MD2 may be formed of an insulated gate bipolar transistor (IGBT).

Note that, in the ejection heater RhA, a piezoelectric element may be used as an element for ejecting the ink. In the circulation heater RhB, a piezoelectric element may be used as an element for circulating the ink. At least one of the ejection heater RhA and the circulation heater RhB may be used as an element for heating a specific area of the print element substrate 18. Alternatively, at least one of the ejection heater RhA and the circulation heater RhB may be used as a temperature detecting element that monitors the temperature of itself.

Each of the ejection drive element MD1 and the circulation drive element MD2 is assumed to be an N-type high-voltage tolerant MOSFET. The high-voltage tolerant MOSFET is a drive element with a higher voltage tolerance than a drive element used in a logic circuit. In the present embodiment, the high-voltage tolerant MOSFET is assumed to be formed such that it does not fail even in a case where a voltage (for example, 32 V) too high for a drive element used in a general logic circuit forming the controller 101 to tolerate is applied.

The print element substrate 18 includes a control data supply circuit 106. An ejection group selection signal line 109, a circulation group selection signal line 110, a time division selection signal line 111, and the enable signal line HE are provided in the print element substrate 18. The control data supply circuit 106 is electrically connected to each of the ejection group selection signal line 109, the circulation group selection signal line 110, the time division selection signal line 111, and the enable signal line HE. Each of the ejection group selection signal line 109, the time division selection signal line 111, and the enable signal line HE is electrically connected to the ejection modules 104. Each of the circulation group selection signal line 110, the time division selection signal line 111, and the enable signal line HE is electrically connected to the circulation modules 105. Accordingly, the control data supply circuit 106 can exchange various signals with the ejection modules 104 via the ejection group selection signal line 109 and the time division selection signal line 111. Moreover, the control data supply circuit 106 can exchange various signals with the circulation modules 105 via the circulation group selection signal line 110 and the time division selection signal line 111.

Specifically, each of the ejection group selection signal line 109, the time division selection signal line 111, and the enable signal line HE is connected to the input sides of the ejection logic circuits AND1. The output sides of the ejection logic circuits AND1 and the gate terminals of the ejection drive elements MD1 are connected to one another. Accordingly, the ejection drive elements MD1 are selected and controlled such that the ejection drive elements MD1 go into a conductive state depending on outputs of the ejection logic circuits AND1, and the currents flow in the ejection heaters RhA. Moreover, each of the circulation group selection signal line 110, the time division selection signal line 111, and the enable signal line HE is connected to the input sides of the circulation logic circuits AND2. The output sides of the circulation logic circuits AND2 and the gate terminals of the circulation drive elements MD2 are connected to one another. Accordingly, the circulation drive elements MD2 are selected and controlled such that the circulation drive elements MD2 go into a conductive state depending on outputs of the circulation logic circuits AND2, and the currents flow in the circulation heaters RhB.

In the present embodiment, the time division selection signal line 111 is shared by the ejection modules 104 and the circulation modules 105. Accordingly, the time division selection signal line 111 can contribute to reduction of a serial data transfer amount and reduction of a wiring layout area of signal lines in the print element substrate 18.

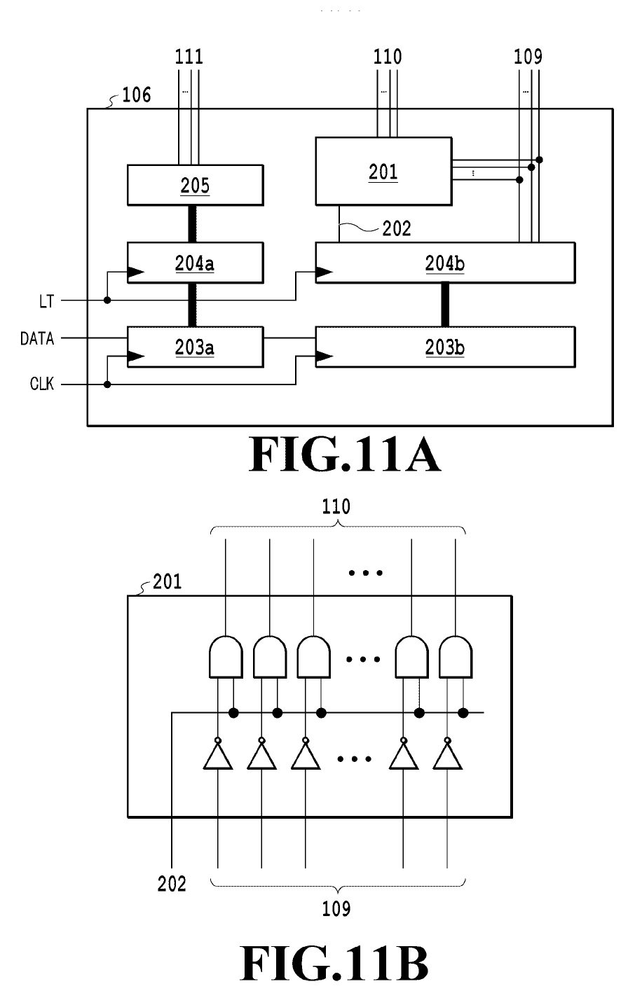

FIG. 11A is a functional block diagram of a circuit configuration of the control data supply circuit 106. FIG. 11B is a diagram illustrating an example of a circuit configuration of a circulation group selection circuit 201 in FIG. 11A. The control data supply circuit 106 includes shift registers 203a and 203b, latch circuits 204a and 204b, a decoder circuit 205, and the circulation group selection circuit 201. The control data supply circuit 106 is provided with external input terminals. The clock signal, the data signal, and the latch signal are supplied from the controller 101 to the control data supply circuit 106 via the external input terminals. The clock signal is a signal used in the case where the data signal is transferred to the shift registers 203a and 203b as serial data. The data signal includes selection information of the ejection modules 104 and selection information of the circulation modules 105. The latch signal is a signal that causes the latch circuits 204a and 204b to obtain and hold various pieces of information stored in the respective shift registers 203a and 203b every latch cycle.

The decoder circuit 205 is a circuit that expands q-bit input data such that the number of bits of output data becomes two to the power of q. Specifically, in the case where 4-bit input data is inputted into the decoder circuit 205, the decoder circuit 205 converts the 4-bit input data to two to the fourth power=16 bit output data. In this case, the output data of the decoder circuit 205 is outputted as information in which only one of the 16 bits is enabled. This allows time division driving of each of the set of the multiple ejection modules 104 and the set of the multiple circulation modules 105 via the time division selection signal line 111.

The circulation group selection circuit 201 includes AND circuits and NOT circuits. Each NOT circuit outputs a signal (hereinafter, also referred to as logically-inverted signal) obtained by logically inverting an ejection group selection signal obtained from the ejection group selection signal line 109. Each AND circuit receives the logically-inverted signal, and also receives a circulation flag signal via a circulation flag signal line 202. The circulation flag signal is included in the data signal serially transferred from the controller 101. The circulation flag signal functions as a flag for setting a circulation group selection signal to enabled or disabled, the circulation group selection signal outputted via the circulation group selection signal line 110. In a normal ejection operation without the ink circulation, the circulation flag signal only needs to be set to 0 to prohibit selection of the circulation modules 105. In other words, the circulation group selection circuit 201 generates the circulation group selection signal depending on selection information of the ejection group selection signal and the circulation flag signal. Accordingly, in the case where the ejection modules 104 are in a selected state, the circulation modules 105 are in a not-selected state. Meanwhile, in the case where the circulation flag signal is 0, even if the ejection modules 104 are in the not-selected state, the circulation group selection signal is disabled, and the circulation modules 105 are not in the selected state. Specifically, in the case where the ejection modules 104 are in the not-selected state and the circulation flag signal is 1, the circulation group selection signal is enabled, and the circulation modules 105 are in the selected state. Note that neither of the ejection modules 104 nor the circulation modules 105 are selected while the time division selection is not performed.

In order to allow the drive elements to operate at a higher voltage than a logic circuit, a substrate in which high-voltage tolerant drive elements and normal drive elements coexist is generally used. In the present embodiment, explanation is given above assuming that the ejection drive element MD1 and the circulation drive element MD2 are high-voltage tolerant MOSFETs. To be more specific, the ejection drive element MD1 and the circulation drive element MD2 are assumed to be formed of double-diffused MOSFETs (DMOSFETs) as the high-voltage tolerant MOSFETs. The logic circuits such as the ejection logic circuit AND1, the circulation logic circuit AND2, the circulation group selection circuit 201, the shift registers 203a and 203b, the latch circuits 204a and 204b, and the decoder circuit 205 are assumed to be formed of MOSFETs with a low tolerable level.

A driving current of the circulation heater RhB generates thermal energy for circulating the ink in the individual channel 23. In the case where the driving current of the circulation heater RhB is smaller than a driving current of the ejection heater RhA that ejects the ink onto the ejection target medium P, a driving capability of the DMOSFET may be low. Accordingly, in this case, the driving current of the circulation heater RhB can be supplied as desired also in a configuration in which the element area of the circulation drive element MD2 is smaller than the element area of the ejection drive element MD1.

In other words, a resistance value of the ejection heater RhA is different from a resistance value of the circulation heater RhB. Accordingly, an element area of the ejection drive element MD1 is different from an element area of the circulation drive element MD2. Moreover, in the case where the driving current supplied from the circulation drive element MD2 to the circulation heater RhB is smaller than the driving current supplied from the ejection drive element MD1 to the ejection heater RhA, the element area of the ejection drive element MD1 is larger than the element area of the circulation drive element MD2.

### First Case

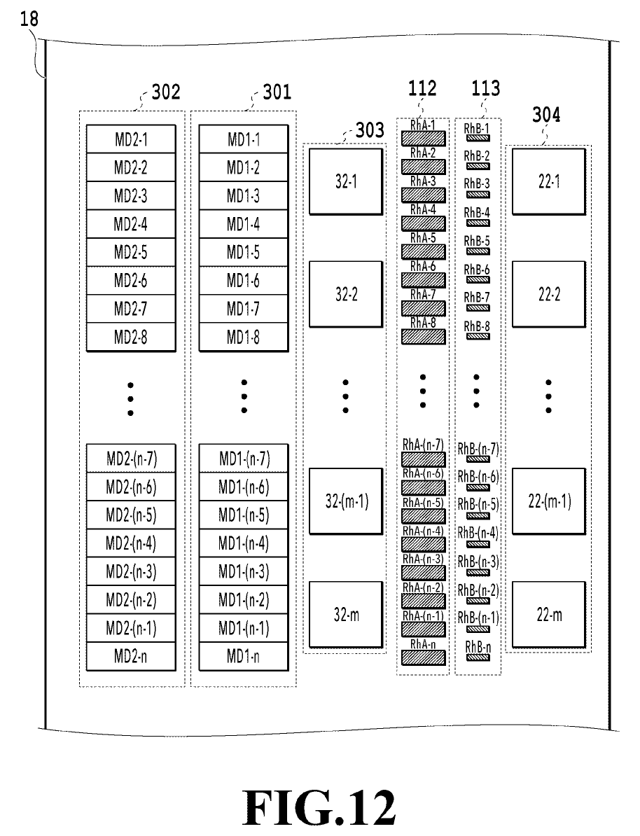

FIG. 12 is a diagram illustrating an arrangement example of heaters and drive elements in a first case according to the present embodiment. In FIG. 12, multiple ejection heaters RhA-1 to RhA-n and multiple circulation heaters RhB-1 to RhB-n are arranged on the print element substrate 18 as the heaters. The multiple ejection heaters RhA-1 to RhA-n form the ejection heater array 112 by being arranged in an array along a long-side direction of the print element substrate 18. The multiple circulation heaters RhB-1 to RhB-n form the circulation heater array 113 by being arranged in an array in the long-side direction of the print element substrate 18. Moreover, in FIG. 12, multiple ejection drive elements MD1-1 to MD1-n and multiple circulation drive elements MD2-1 to MD2-n are arranged on the print element substrate 18 as the drive elements. The multiple ejection drive elements MD1-1 to MD1-n form an ejection drive element array 301 by being arranged in an array along the long-side direction of the print element substrate 18. The multiple circulation drive elements MD2-1 to MD2-n form a circulation drive element array 302 by being arranged in an array along the long-side direction of the print element substrate 18.

Moreover, in FIG. 12, supply port arrays 303 and 304 are formed in the print element substrate 18 in addition to the ejection heater array 112, the circulation heater array 113, the ejection drive element array 301 (also referred to as first drive element array), and the circulation drive element array 302 (also referred to as second drive element array). The supply port array 303 is formed by arranging multiple supply ports 32-1 to 32-m in an array along the long-side direction of the print element substrate 18. The supply port array 304 is formed by arranging multiple supply ports 22-1 to 22-m in an array along the long-side direction of the print element substrate 18. In the present embodiment, the circulation heater array 113 is arranged on the left side of and in parallel with the supply port array 304. The ejection heater array 112 is arranged on the left side of and in parallel with the circulation heater array 113. The supply port array 303 is arranged on the left side of and in parallel with the ejection heater array 112. The ejection drive element array 301 is arranged on the left side of and in parallel with the supply port array 303. The circulation drive element array 302 is arranged on the left side of and in parallel with the ejection drive element array 301.

Moreover, although one supply port 22 and one supply port 32 are arranged for every four ejection heaters RhA and every four circulation heaters RhB in the present embodiment, the present disclosure is not limited to this arrangement. Furthermore, the size of the supply ports 22 may be different from the size of the supply ports 32. Moreover, the number of the supply ports 22 does not have to be the same as the number of the supply ports 32. Furthermore, although the ejection heater array 112 is arranged in a region closer to a region in which the ejection drive element array 301 is arranged than the circulation heater array 113 is, the present disclosure is not limited to this arrangement. The circulation heater array 113 may be arranged in a region closer to the region in which the ejection drive element array 301 is arranged than the ejection heater array 112 is. Moreover, in the present embodiment, the ejection drive element array 301 is arranged in a region closer to a heating resistance element region in which the ejection heater array 112 and the circulation heater array 113 are arranged, than the circulation drive element array 302 is. Specifically, the circulation drive element array 302 is arranged at a position farther away from the heating resistance element region than the ejection drive element array 301 is. Moreover, a resistance value of the ejection heaters RhA may be equivalent to or different from a resistance value of the circulation heaters RhB. Furthermore, the size of the ejection heaters RhA may be equivalent to or differ from the size of the circulation heaters RhB.

Note that the heating resistance element region is a region in which the heating resistance elements are arranged on the same layer in the print element substrate 18. In the present embodiment, at least one of the set of the ejection heaters RhA and the set of the circulation heaters RhB is used as the heating resistance elements. Accordingly, the heating resistance element region is a region in which at least one of the set of the ejection heaters RhA and the set of the circulation heaters RhB is arranged in the print element substrate 18. For example, a region including the ejection heater array 112 and the circulation heater array 113 on the same layer in the print element substrate 18 is the heating resistance element region. Specifically, multiple ejection heaters RhA formed as the ejection heater array 112 are arranged in a first region of the heating resistance element region. Moreover, multiple circulation heaters RhB formed as the circulation heater array 113 are arranged in a second region of the heating resistance element region. Note that, in the case where other heating resistance elements are arranged, the other heating resistance elements may be arranged in a third region of the heating resistance element region.

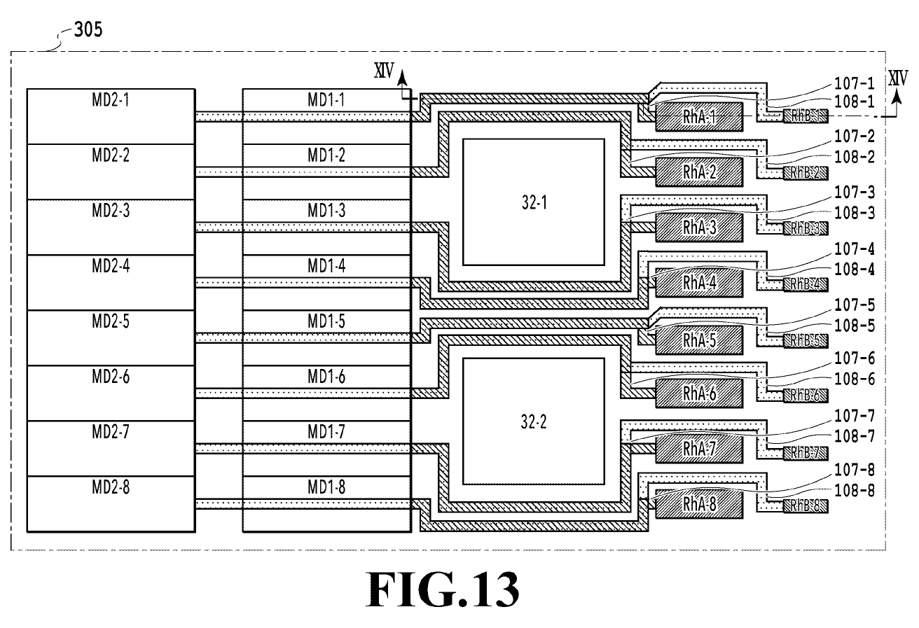

FIG. 13 is a partial enlarged diagram of the arrangement example of the heaters and the drive elements in the first case in FIG. 12. In FIG. 13, ejection drain wiring lines 107-1 to 107-8 and circulation drain wiring lines 108-1 to 108-8 are laid out as constituent elements of a unit 305 formed in the print element substrate 18. Specifically, the unit 305 includes the ejection drain wiring lines 107-1 to 107-8 and the circulation drain wiring lines 108-1 to 108-8. Moreover, the unit 305 further includes supply ports 32-1 and 32-2, ejection drive elements MD1-1 to MD1-8, circulation drive elements MD2-1 to MD2-8, ejection heaters RhA-1 to RhA-8, and circulation heaters RhB-1 to RhB-8.

Specifically, the circulation drain wiring lines 108-1 to 108-4 pass through a periphery of the supply port 32-1, and connect the circulation heaters RhB-1 to RhB-4 and the circulation drive elements MD2-1 to MD2-4 to one another. The circulation drain wiring lines 108-5 to 108-8 pass through a periphery of the supply port 32-2, and connect the circulation heaters RhB-5 to RhB-8 and the circulation drive elements MD2-5 to MD2-8 to one another.

The ejection drain wiring lines 107-1 to 107-4 pass through the periphery of the supply port 32-1, and connect the ejection heaters RhA-1 to RhA-4 and the ejection drive elements MD1-1 to MD1-4 to one another. The ejection drain wiring lines 107-5 to 107-8 pass through the periphery of the supply port 32-2, and connect the ejection heaters RhA-5 to RhA-8 and the ejection drive elements MD1-5 to MD1-8 to one another.

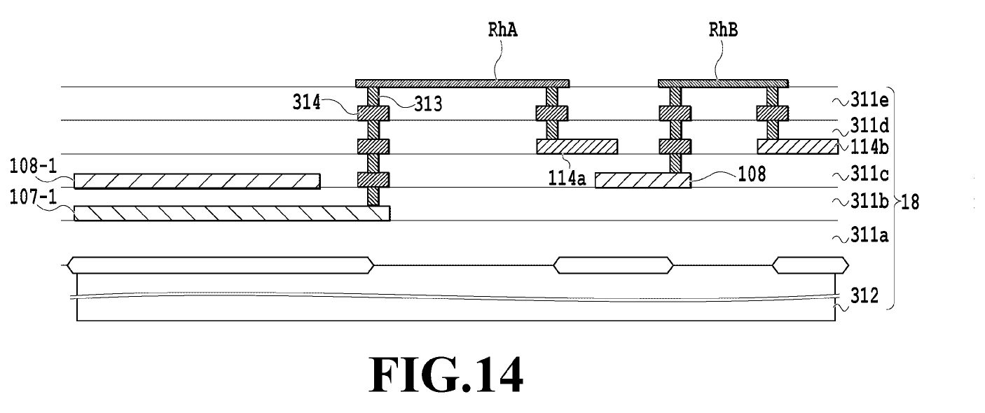

In essence, among the ejection drain wiring lines 107 and the circulation drain wiring lines 108, there are lines laid out to pass through regions between the supply ports 32. Note that, in the present embodiment, four ejection drain wiring lines 107 and four circulation drain wiring lines 108 are laid out per supply port 32 to pass through the periphery of the supply port 32. However, the number of laid-out lines is not limited to four. Moreover, although an example in which the wiring width of the ejection drain wiring lines 107 is identical to the wiring width of the circulation drain wiring lines 108 is illustrated in FIG. 13, the present disclosure is not limited to this. The wiring width of the ejection drain wiring lines 107 may be different from the wiring width of the circulation drain wiring lines 108. Next, a layer configuration of the print element substrate 18 is explained by using FIG. 14.

FIG. 14 is a diagram illustrating a cross-sectional structure along the XIV-XIV line in FIG. 13. The print element substrate 18 can be manufactured by a publicly-known semiconductor manufacturing process. For example, the print element substrate 18 includes a substrate 312 and multiple electric elements. The substrate 312 is made of a semiconductor such as single crystal silicon. The multiple electric elements are provided on the substrate 312.

### Insulation Layers 311

Specifically, insulation layers 311 are formed on the substrate 312. For example, an inorganic material such as silicon oxide is used in the insulation layers 311. The insulation layers 311 have a function of electrical separation. For example, in the present embodiment, the insulation layers 311 electrically separate the ejection heater RhA and the circulation heater RhB from each other. Moreover, although illustration is omitted in FIG. 14, the insulation layers 311 electrically separate the ejection drive element MD1 and the circulation drive element MD2 from each other.

In the present embodiment, the insulation layers 311 include insulation layers 311a, 311b, 311c, 311d, and 311e. A wiring layer including the ejection drain wiring line 107-1 is formed in the insulation layer 311b. Wiring layers including the respective ejection drain wiring lines 107-2 to 107-8 are also formed in the insulation layer 311b. A wiring layer including the circulation drain wiring line 108-1 is formed in the insulation layer 311c. Wiring layers including the respective circulation drain wiring lines 108-2 to 108-8 are also formed in the insulation layer 311c. Specifically, the circulation drain wiring lines 108 (also referred to as second wiring lines) are formed in a different layer from the ejection drain wiring lines 107 (also referred to as first wiring lines). In the present embodiment, the layer in which the circulation drain wiring lines 108 are formed is above the layer in which the ejection drain wiring lines 107 are formed. Moreover, power supply voltage wiring lines VH114a and VH114b are formed in the insulation layer 311d.

### Connection Members 313

Connection members 313 are provided in a via penetrating the insulation layers 311b to 311e. In FIG. 14, the connection members 313 are also provided in a via penetrating the insulation layers 311d to 311e and a via penetrating the insulation layers 311c to 311e. Contact plugs are provided inside these vias to form the connection members 313 in an electrically-connectable state. The connection members 313 are provided to electrically connect conductive layers 314, an electric element in an upper layer, an electrical element in a lower layer, an electric element in a layer between the upper layer and the lower layer, and the like to one another. The electric elements include an electrode layer of the ejection drive element MD1 and the circulation drive element MD2. In this example, the upper layer collectively refers to layers present in a direction away from the substrate 312 with a certain layer being a reference. The lower layer collectively refers to layers present in a direction toward the substrate 312 with a certain layer being a reference. For example, in the case where the insulation layer 311d is the layer being the reference, for example, the insulation layer 311e corresponds to the upper layer. Moreover, for example, the insulation layers 311c, 311b, and 311a correspond to the lower layer. Note that, in the present embodiment, the conductive layers 314 are provided in the insulation layers 311c, 311d, and 311e, respectively. Accordingly, the electric elements included in the respective insulation layers 311b, 311c, 311d, and 311e are electrically connectable to one another via the connection members 313 and the conductive layers 314.

In FIG. 14, the ejection heater RhA and the circulation heater RhB are arranged on a top surface of the insulation layer 311e that is the upper layer of the insulation layers 311. Specifically, the ejection heater RhA and the circulation heater RhB are arranged on the same layer. Moreover, in FIG. 14, part of the ejection heater RhA is electrically connectable to the ejection drain wiring line 107-1 via the connection members 313 and the conductive layers 314. Furthermore, part of the circulation heater RhB is electrically connectable to the circulation drain wiring line 108-1 via the connection members 313 and the conductive layers 314. Another part of the ejection heater RhA is electrically connectable to the power supply voltage wiring line VH114a via the connection members 313 and the conductive layers 314. Another part of the circulation heater RhB is electrically connectable to the power supply voltage wiring line VH114b via the connection members 313 and the conductive layers 314. Although the power supply voltage wiring line VH114a and the power supply voltage wiring line VH114b are connected in common in the present embodiment, the power supply voltage wiring line VH114a and the power supply voltage wiring line VH114b may be configured to be individually connected and individually supplied with power supply voltages.

Note that, although the GNDH wiring line 115 of FIG. 10 is assumed to be arranged in the upper layer of the power supply voltage wiring lines VH114 in FIG. 14 in the present embodiment, the configuration is not limited to this. The GNDH wiring line 115 of FIG. 10 may be in the lower layer of the power supply voltage wiring lines VH114. Alternatively, the GNDH wiring line 115 in FIG. 10 may be in the same layer as the power supply voltage wiring lines VH114.

Moreover, the electrode layer of the ejection drive elements MD1-1 to MD1-8 in FIG. 13 and the electrode layer of the circulation drive elements MD2-1 to MD2-8 in FIG. 13 are formed in the same layer as the ejection drain wiring lines 107. Specifically, the circulation drive element array 302 is arranged on the same layer as the ejection drive element array 301 in parallel with the ejection drive element array 301. The electrode layer of the ejection drive elements MD1-1 to MD1-8 in FIG. 13 includes drain electrodes, source electrodes, and gate electrodes of the ejection drive elements MD1-1 to MD1-8 in FIG. 13. The electrode layer of the circulation drive elements MD2-1 to MD2-8 in FIG. 13 includes drain electrodes, source electrodes, and gate electrodes of the circulation drive elements MD2-1 to MD2-8 in FIG. 13. Moreover, the electrode layer of each of the ejection drive elements MD1 and a corresponding one of the ejection drain wiring lines 107 are connected to each other. The electrode layer of each of the circulation drive elements MD2 and a corresponding one of the circulation drain wiring lines 108 are connected to each other. According to the above explanation, the circulation drain wiring line 108 and the ejection drain wiring line 107 are formed in different layers. Moreover, the electrode layer of the circulation drive element MD2 is formed in the same layer as the ejection drain wiring line 107. Accordingly, the circulation drain wiring line 108 and the electrode layer of the circulation drive element MD2 are in different layers. Thus, the electrode layer of the circulation drive element MD2 is electrically connectable to the circulation drain wiring line 108 via the connection member 313 and the conductive layer 314 in the same layer as the circulation drain wiring line 108. Specifically, the wiring layer in which the circulation drain wiring line 108 is formed is a different layer from the electrode layer of the circulation drive element MD2, and is subjected to electrical inter-layer connection with the electrode layer of the circulation drive element MD2 via the via. Note that, according to the above explanation, the wiring layer in which the ejection drain wiring line 107 is formed is formed in the same layer as the electrode layer of the ejection drive element MD1 and the electrode layer of the circulation drive element MD2.

Moreover, the ejection heater RhA and the circulation heater RhB may be made of a metal with a relatively large electric resistance such as, for example, tantalum silicon nitride or tungsten silicon nitride. Although not illustrated in FIG. 14, it is assumed that the ejection drive element MD1 and the circulation drive element MD2 are provided in the same semiconductor layer, and as explained above, are both formed of N-type MOSFETs. Moreover, the connection members 313, the conductive layers 314, the ejection drain wiring line 107-1, the circulation drain wiring line 108-1, and the power supply voltage wiring lines VH114 are made of a metal with a relatively small electrical resistance. For example, the connection members 313 are made of tungsten, copper, or the like. Moreover, for example, the conductive layers 314, the ejection drain wiring line 107-1, the circulation drain wiring line 108-1, and the power supply voltage wiring lines VH114 are made of, for example, aluminum, copper, or the like. Moreover, in the present embodiment, the ejection drain wiring line 107-1 and the circulation drain wiring line 108-1 are formed in layers different from each other, and are thereby laid out in total of two layers. Furthermore, the circulation drain wiring line 108-1 is formed in the upper layer of the ejection drain wiring line 107-1.

Moreover, in FIG. 13, although there appears to be a portion where part of the ejection drain wiring line 107-1 and part of the circulation drain wiring line 108-1 coincide with each other, this is an example in which the ejection drain wiring line 107-1 and the circulation drain wiring line 108-1 have the same wiring width. As illustrated in FIG. 14, the ejection drain wiring line 107-1 and the circulation drain wiring line 108-1 are formed in the different layers.

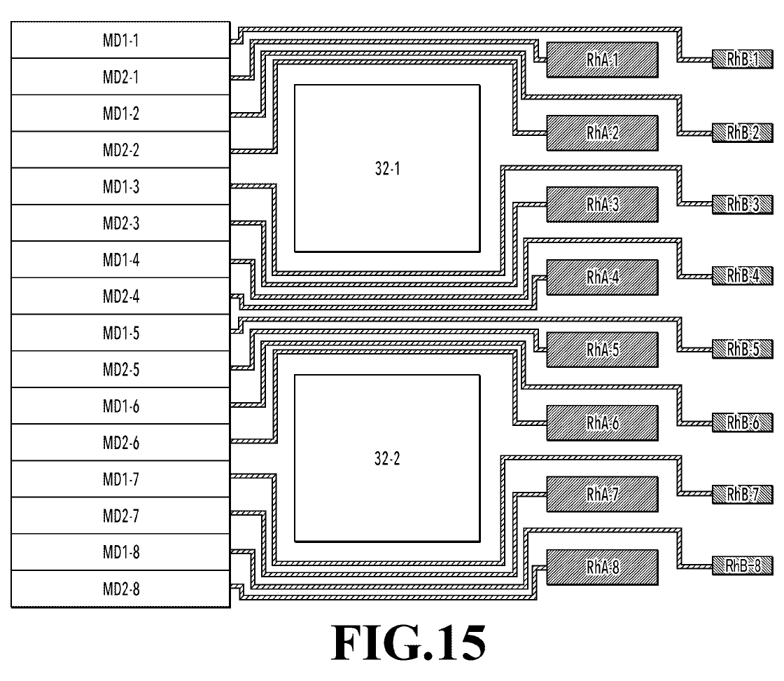

Note that, in present embodiment, the electric elements of the conductive layers 314, the ejection drain wiring line 107-1, the circulation drain wiring line 108-1, and the power supply voltage wiring lines VH114 are formed in layers different from one another to be formed in total of four layers. However, the present disclosure is not limited to this configuration. The number of layers in which the electric elements are formed may be different from that in the present embodiment. Next, a comparative example is explained by using FIG. 15.

### Arrangement Comparative Example

FIG. 15 is a diagram illustrating an arrangement comparative example of the heaters and the drive elements. In FIG. 15, the ejection drain wiring lines and the circulation drain wiring lines are assumed to be laid out in the same layer. Accordingly, a region for passing of the ejection drain wiring lines and the circulation drain wiring lines cannot be sufficiently secured between the supply port 32-1 and the supply port 32-2. Thus, in the arrangement comparative example of FIG. 15, the wiring width of each of the ejection drain wiring lines and the circulation drain wiring lines is smaller than a desired wiring width. Moreover, the ejection drive elements MD1 and the circulation drive elements MD2 are alternately arranged in an array. Accordingly, a region for arranging the ejection drive elements MD1 and the circulation drive elements MD2 cannot be sufficiently secured. Thus, in the arrangement comparative example of FIG. 15, the size of each of the ejection drive elements MD1 and the circulation drive elements MD2 is smaller than a desired size.

### Effects of First Case

According to the above explanation, in the first case, the ejection drain wiring line 107 and the circulation drain wiring line 108 are laid out in total of two layers that are different layers. Accordingly, the ejection drain wiring line 107 and the circulation drain wiring line 108 are not laid out on the same layer, and one drain wiring line is laid out in one layer. Accordingly, a region in which the wiring lines can pass between the supply ports 32 is doubled. A region for laying out the drain wiring line in each layer can be thereby sufficiently secured. Accordingly, the wiring width of each drain wiring line can be secured as desired. Thus, the drive elements such as the ejection drive elements MD1 and the circulation drive elements MD2 can be appropriately arranged in the print element substrate 18.

Moreover, the ejection drive element array 301 and the circulation drive element array 302 are arranged in two arrays along the long-side direction of the print element substrate 18. A region in which the drive elements can be laid out is thereby doubled. Thus, the size of each drive element can be set to a desired size.

Furthermore, the ejection drive element array 301 is arranged in the region closer to the region in which the ejection heater array 112 and the circulation heater array 113 are arranged, than the circulation drive element array 302 is. The wiring resistance of the ejection drain wiring line 107 can be thereby made smaller than the wiring resistance of the circulation drain wiring line 108. Accordingly, for the ejection heater RhA that consumes more energy than the circulation heater RhB, energy consumed in the ejection drain wiring line 107 can be made smaller than that in the circulation drain wiring line 108. Thus, the ejection heater RhA can be efficiently driven.

### Second Case

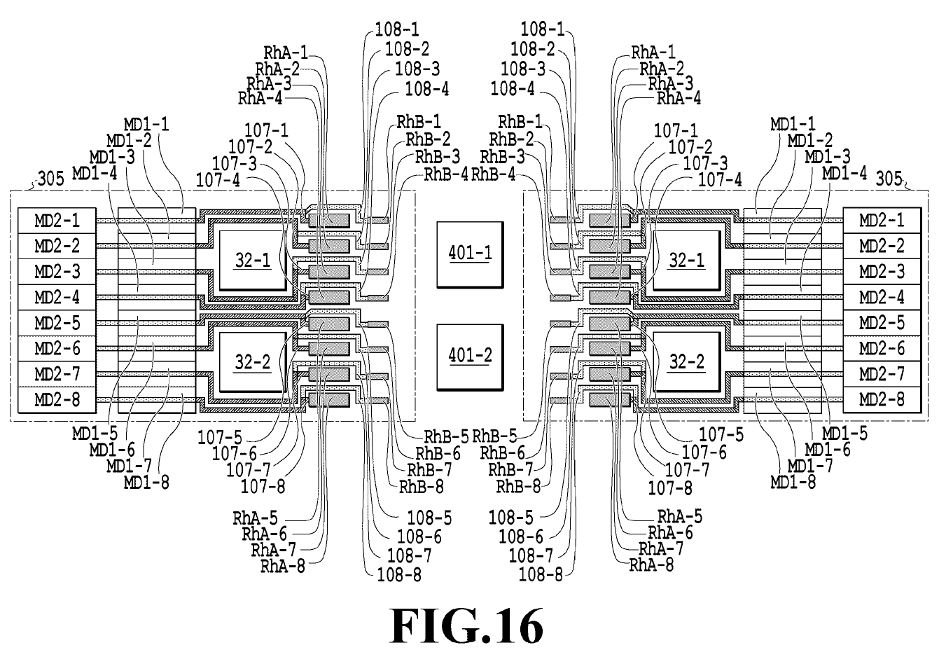

FIG. 16 is a diagram illustrating an arrangement example of the heaters and the drive elements in a second case according to the present embodiment. The second case is different from the first case in that multiple units 305 are provided. In the second case, the layout is such that the units 305 are symmetrically arranged with respect to the long-side direction of the print element substrate 18. Moreover, in the second case, the layout is such that supply ports 401-1 and 401-2 are provided between the units 305. In such a layout, the supply ports 401-1 and 401-2 have a function of supplying the ink to each unit 305. Accordingly, the size reduction of the print element substrate 18 may be possible.

Specifically, each unit 305 includes an ejection drive element array, a circulation drive element array, and a heating resistance element region. The ejection drive element array includes the ejection drive elements MD1-1 to MD1-8. The circulation drive element array includes the circulation drive elements MD2-1 to MD2-8. The heating resistance element region includes the ejection heaters RhA-1 to RhA-8 and the circulation heaters RhB-1 to RhB-8. Two units 305 are formed in the present embodiment. The units 305 are symmetrically arranged about the supply ports 401 such that the heating resistance element regions face each other. In such an arrangement configuration, the units 305 are arranged on both sides of the supply ports 401. Accordingly, the supply ports 401 can supply the ink to each unit 305. Thus, the size of the entire print element substrate 18 can be reduced.

Note that the size of the supply ports 401-1 and 401-2 may be the same as the size of the supply ports 32-1 and 32-2, or different therefrom. Moreover, although the example in which the number of the supply ports 401 and the number of the supply ports 32 are the same is illustrated in the second case, the number of the supply ports 401 may be different from the number of the supply ports 32. Furthermore, although the example in which eight ejection heaters RhA are arranged for one supply port 401 is illustrated, the number of the ejection heaters RhA is not limited to eight. The same applies to the circulation heaters RhB. Moreover, although the example in which there are two units 305 is illustrated, there may be three or more units 305. Specifically, in the second case, at least two units 305 are formed.

### Third Case

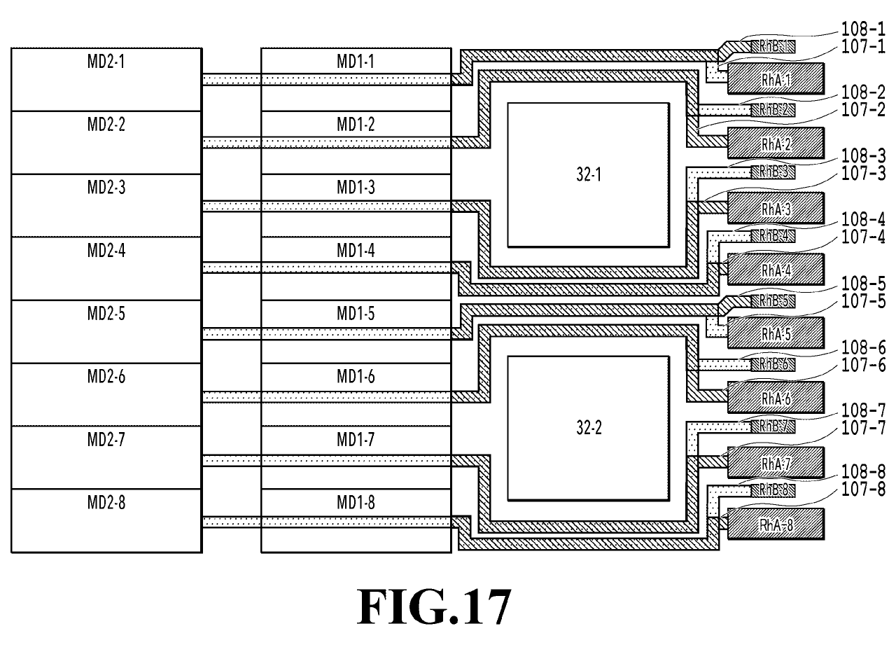

FIG. 17 is a diagram illustrating an arrangement example of the heaters and the drive elements in a third case according to the present embodiment. The third case is different from the first and second cases in that the ejection heaters RhA and the circulation heaters RhB are laid out in an array. In such a layout, there is no need to secure an arrangement region for two arrays of the ejection heaters RhA and the circulation heaters RhB. Accordingly, the size reduction of the print element substrate 18 may be possible. Specifically, the ejection heaters RhA and the circulation heaters RhB are alternately arranged in an array. In such an arrangement configuration, the size of the heating resistance element region including the ejection heaters RhA and the circulation heaters RhB can be reduced. Accordingly, the size of the entire print element substrate 18 can be reduced.

### Other Examples

Although the first to third cases of the present embodiment have been explained above, the present invention is not limited to the values, the forms, and the numbers described above, and elements are provided depending on the configuration of the print element substrate 18. For example, the number of nozzles per nozzle array is not limited to 8 or 16. For example, the number of nozzles per nozzle array may be 512. Moreover, the nozzle array itself is not limited to one array or two array, and may be multiple arrays that are three or more arrays.

### Other Embodiments

Although various examples and the embodiment of the present disclosure have been illustrated and explained above, the spirit and the scope of the present disclosure are not limited to specific explanation of the present specification. The present disclosure is not limited to the above-mentioned embodiment, and various modifications can be made. Moreover, in the present disclosure, parts of the above-mentioned embodiment may be combined as appropriate.

### Modified Example 1

For example, although the example in which the vias are used for electrical connection with the other wiring layers is explained in the present embodiment, the present disclosure is not limited to this example. For example, instead of the vias that achieves electrical conduction between one wiring layer and another wiring layer among multiple wiring layers stacked one on top of another, electrically-conductive cover layer may be applied to through holes penetrating all wiring layers.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to appropriately arrange the drive elements in the print element substrate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071736, filed April 23, 2025, which is hereby incorporated by reference herein in its entirety.

What is claimed is:

1. A print element substrate comprising:
a first drive element array including a plurality of first drive elements configured to drive a plurality of first heating resistance elements, the plurality of first drive elements being arranged in an array;
a second drive element array including a plurality of second drive elements configured to drive a plurality of second heating resistance elements, the plurality of second drive elements being arranged in an array;
a plurality of first wiring lines configured to connect the plurality of first heating resistance elements and the plurality of first drive elements; and
a plurality of second wiring lines configured to connect the plurality of second heating resistance elements and the plurality of second drive elements, wherein
the second drive element array is arranged on a same layer as the first drive element array in parallel with the first drive element array, and is arranged at a position farther away from a heating resistance element region than the first drive element array, the heating resistance element region including the plurality of first heating resistance elements and the plurality of second heating resistance elements being arranged, and
the plurality of second wiring lines are formed in a different layer from the plurality of first wiring lines.

2. The print element substrate according to claim 1, wherein a resistance value of each of the plurality of first heating resistance elements is different from a resistance value of each of the plurality of second heating resistance elements.

3. The print element substrate according to claim 1, wherein an element area of the first drive elements is different from an element area of the second drive elements.

4. The print element substrate according to claim 1, wherein an element area of the first drive elements is larger than an element area of the second drive elements.

5. The print element substrate according to claim 1, wherein a driving current supplied from the first drive elements to the first heating resistance elements is different from a driving current supplied from the second drive elements to the second heating resistance elements.

6. The print element substrate according to claim 1, wherein a driving current to the first heating resistance elements is larger than a driving current to the second heating resistance elements.

7. The print element substrate according to claim 1, further comprising a plurality of first supply ports configured to supply liquid and provided between the heating resistance element region and a set of the plurality of first drive elements and the plurality of second drive elements.

8. The print element substrate according to claim 7, wherein the first wiring lines and the second wiring lines are arranged to pass through between each of the first supply ports.

9. The print element substrate according to claim 1, wherein a layer in which the second wiring lines are formed is above a layer in which the first wiring lines are formed.

10. The print element substrate according to claim 1, wherein a wiring layer in which the second wiring lines are formed is a layer different from an electrode layer of the second drive elements, and is subjected to electrical interlayer connection with the electrode layer of the second drive elements through a via.

11. The print element substrate according to claim 1, wherein a wiring layer in which the first wiring lines are formed is formed in a same layer as an electrode layer of the first drive elements and an electrode layer of the second drive elements.

12. The print element substrate according to claim 1, further comprising:
a first heating resistance element array including the plurality of first heating resistance elements being arranged in an array in a first region of the heating resistance element region; and
a second heating resistance element array being arranged in a same layer as the first heating resistance element array in parallel with the first heating resistance element array in a second region in the heating resistance element region, and including the plurality of second heating resistance elements, the plurality of second heating resistance elements being arrange in a array, wherein
the first heating resistance element array being arranged at a position closer to the first drive element array than the second heating resistance element array in a direction orthogonal to an array direction of the first drive element array.

13. The print element substrate according to claim 1, further comprising:
a second supply port configured to supply an ink; and
a unit including the first drive element array, the second drive element array, and the heating resistance element region, wherein
at least two of the units are formed, and
each of the units is symmetrically arranged about the second supply port such that the heating resistance element regions face each other.

14. The print element substrate according to claim 1, wherein the plurality of first heating resistance elements and the plurality of second heating resistance elements are alternately arranged in an array.

15. The print element substrate according to claim 1, further comprising a power supply wiring line electrically connected to each of the first heating resistance elements and the second heating resistance elements and configured to supply power.

16. The print element substrate according to claim 1, further comprising a ground wiring line electrically connected to each of the first drive elements and the second drive elements and configured to set a reference potential.

17. The print element substrate according to claim 1, wherein the first drive elements are ejection drive elements, and the second drive elements are circulation drive elements.
